(19) United States
(12) Patent Application Publication
(10) Pub. No.: US 2026/0333460 A1
(43) Pub. Date: Oct. 22, 2026

(54) RANDOM ACCESS CHANNEL CONFIGURATION FOR MULTIPLE CARRIERS

(71) Applicant: Lenovo (United States) Inc., Morrisville, NC (US)

(72) Inventors: Karthikeyan Ganesan, Nauheim (DE); Ravi Kuchibhotla, Chicago, IL (US)

(73) Assignee: Lenovo (United States) Inc., Morrisville, NC (US)

(21) Appl. No.: 19/569,476

(22) Filed: Mar. 17, 2026

(51) Int. Cl. H04W 74/0833; H04B 17/318

(52) U.S. Cl. CPC H04W 74/0833; H04B 17/328

(57) ABSTRACT

Various aspects of the present disclosure relate to random access channel configuration for multiple carriers. A user equipment (UE) may receive signaling from a network equipment (NE) that indicates a set of random access channel (RACH) occasions for a random access procedure. The set of RACH occasions are spread across a set of carriers associated with a cell. The UE may select a RACH occasion of the set of RACH occasions based on at least one of a UE type associated with the UE, a radio frequency capability associated with the UE, or one or more measurements associated with the set of carriers. The RACH occasion is associated with a carrier of the set of carriers. The UE may transmit a RACH preamble of the random access procedure to the NE based on (e.g., during) the RACH occasion.

### TECHNICAL FIELD

The present disclosure relates to wireless communications, and more specifically to resource allocation for random access.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies, including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, a “set” may include one or more elements.

As used herein, including in the claims, “satisfying a threshold” may refer to a value being greater than the threshold, greater than or equal to the threshold, less than the threshold, less than or equal to the threshold, equal to the threshold, not equal to the threshold, or the like.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive signaling that indicates a set of random access channel (RACH) occasions for a random access procedure, where the set of RACH occasions are spread across (e.g., distributed to, located at) a set of carriers associated with a cell, select, based on at least one of a UE type associated with the UE, a radio frequency capability associated with the UE, or one or more measurements associated with the set of carriers, a RACH occasion of the set of RACH occasions, where the RACH occasion is associated with a carrier of the set of carriers, and transmit a RACH preamble of the random access procedure based on the RACH occasion.

A processor (e.g., a standalone processor chipset, or a component of a UE) for wireless communication is described. The processor may be configured to, capable of, or operable to perform one or more operations as described herein. For example, the processor may be configured to, capable of, or operable to receive signaling that indicates a set of RACH occasions for a random access procedure, where the set of RACH occasions are spread across a set of carriers associated with a cell, select, based on at least one of a UE type associated with the UE, a radio frequency capability associated with the UE, or one or more measurements associated with the set of carriers, a RACH occasion of the set of RACH occasions, where the RACH occasion is associated with a carrier of the set of carriers, and transmit a RACH preamble of the random access procedure based on the RACH occasion.

A method performed or performable by a UE for wireless communication is described. The method may include receiving signaling that indicates a set of RACH occasions for a random access procedure, where the set of RACH occasions are spread across a set of carriers associated with a cell, selecting, based on at least one of a UE type associated with the UE, a radio frequency capability associated with the UE, or one or more measurements associated with the set of carriers, a RACH occasion of the set of RACH occasions, where the RACH occasion is associated with a carrier of the set of carriers, and transmitting a RACH preamble of the random access procedure based on the RACH occasion.

In some implementations of the UE, the processor, and the method described herein, the UE, the processor, and the method may further be configured to, capable of, or operable to select the RACH occasion based on the UE type, where the carrier includes one of a first bandwidth based on the UE being a first UE type or a second bandwidth greater than the first bandwidth based on the UE being a second UE type. In some implementations, the RACH occasion is selected based on the radio frequency capability associated with the UE, and the carrier includes one of a first carrier based on the radio frequency capability including a single radio frequency chain, a second carrier associated with a reference signal received power (RSRP) based on the radio frequency capability including a set of radio frequency chains, or a third carrier associated with a pathloss based on the radio frequency capability including a reduced power capability. In some implementations, the UE, the processor, and the method may further be configured to, capable of, or operable to receive one or more reference signals, and perform, for respective carriers of the set of carriers, the one or more measurements associated with the one or more reference signals, where the RACH occasion is selected based on one or more threshold values associated with the one or more measurements, and where the one or more measurements for the carrier satisfy the one or more threshold values.

In some implementations, the UE, the processor, and the method may further be configured to, capable of, or operable to determine an identifier (e.g., a random access-radio network temporary identifier (RNTI) (RA-RNTI)) associated with a random access response (RAR) of the random access procedure, where the identifier is based on one or more of a time index associated with the RACH preamble, a frequency index associated with the RACH preamble, a carrier index associated with the carrier, or a bandwidth part (BWP) identifier associated with the carrier, and monitor for the RAR based on at least one carrier of the set of carriers, where the RAR includes the carrier index. In some implementations, to monitor for the RAR, the UE, the processor, and the method may further be configured to, capable of, or operable to receive the RAR based on monitoring the carrier, where the at least one carrier includes the carrier. In some implementations, to monitor for the RAR, the UE, the processor, and the method may further be configured to, capable of, or operable to receive the RAR based on monitoring the set of carriers, where the at least one carrier includes the RAR associated with the identifier.

In some implementations, the UE, the processor, and the method may further be configured to, capable of, or operable to transmit a third message (e.g., Msg3) of the random access procedure on the carrier. In some implementations, the UE, the processor, and the method may further be configured to, capable of, or operable to receive a grant that indicates at least one of a carrier index or a BWP identifier associated with an additional carrier of the set of carriers, and transmit a third message (e.g., Msg3) of the random access procedure on the additional carrier. In some implementations, the UE, the processor, and the method may further be configured to, capable of, or operable to transmit, based on a signal-to-noise ratio (SNR) associated with the RACH preamble satisfying a threshold value, a Msg3 across two or more carriers of the set of carriers.

In some implementations, the signaling includes respective RACH configuration indices associated with the set of carriers that indicate one or more of a physical RACH (PRACH) configuration index, a PRACH periodicity, a slot offset, or one or more PRACH time-domain occasions, and the UE, the processor, and the method may further be configured to, capable of, or operable to determine, for respective carriers of the set of carriers, an earliest RACH occasion for the random access procedure, where the carrier includes the earliest RACH occasion of the respective carriers. In some implementations, the UE, the processor, and the method may further be configured to, capable of, or operable to select one or more additional RACH occasions of the set of RACH occasions, where the one or more additional RACH occasions are associated with one or more additional carriers of the set of carriers, and transmit one or more repetitions of the RACH preamble based on the one or more additional RACH occasions.

In some implementations, the signaling includes one or more of a PRACH configuration index that indicates the set of RACH occasions, a preamble format associated with the RACH preamble, a zero correlation zone, or one or more power ramping parameters. In some implementations, respective carriers of the set of carriers are associated with a BWP identifier, and the signaling indicates the BWP identifier. In some implementations, the set of carriers are associated with the cell based on the set of carriers sharing one or more of a physical cell identifier (PCI), a cell identifier, a synchronization raster, a RACH configuration index, system information, or a radio frequency.

An NE (e.g., a base station) for wireless communication is described. The NE may be configured to, capable of, or operable to perform one or more operations as described herein. For example, the NE may be configured to, capable of, or operable to transmit signaling that indicates a set of RACH occasions for a random access procedure, where the set of RACH occasions are spread across a set of carriers associated with a cell, and receive, from a UE and based on at least one of a UE type associated with the UE, a radio frequency capability associated with the UE, or one or more measurements associated with the set of carriers, a RACH preamble of the random access procedure on a RACH occasion of the set of RACH occasions, where the RACH occasion is associated with a carrier of the set of carriers.

A processor (e.g., a standalone processor chipset, or a component of an NE) for wireless communication is described. The processor may be configured to, capable of, or operable to perform one or more operations as described herein. For example, the processor may be configured to, capable of, or operable to transmit signaling that indicates a set of RACH occasions for a random access procedure, where the set of RACH occasions are spread across a set of carriers associated with a cell, and receive, from a UE and based on at least one of a UE type associated with the UE, a radio frequency capability associated with the UE, or one or more measurements associated with the set of carriers, a RACH preamble of the random access procedure on a RACH occasion of the set of RACH occasions, where the RACH occasion is associated with a carrier of the set of carriers.

A method performed or performable by an NE (e.g., a base station) for wireless communication is described. The method may include transmitting signaling that indicates a set of RACH occasions for a random access procedure, where the set of RACH occasions are spread across a set of carriers associated with a cell, and receiving, from a UE and based on at least one of a UE type associated with the UE, a radio frequency capability associated with the UE, or one or more measurements associated with the set of carriers, a RACH preamble of the random access procedure on a RACH occasion of the set of RACH occasions, where the RACH occasion is associated with a carrier of the set of carriers.

In some implementations of the NE, the processor, and the method described herein, the NE, the processor, and the method may further be configured to, capable of, or operable to determine an identifier associated with an RAR of the random access procedure, where the identifier is based on one or more of a time index associated with the RACH preamble, a frequency index associated with the RACH preamble, a carrier index associated with the carrier, or a BWP identifier associated with the carrier, and transmit the RAR based on the identifier, where the RAR includes the carrier index. In some implementations, the NE, the processor, and the method may further be configured to, capable of, or operable to receive a Msg3 of the random access procedure on the carrier.

In some implementations, the NE, the processor, and the method may further be configured to, capable of, or operable to transmit a grant that indicates at least one of a carrier index or a BWP identifier associated with an additional carrier of the set of carriers, and receive a Msg3 of the random access procedure on the additional carrier. In some implementations, the grant is transmitted based on a power margin associated with the RACH preamble satisfying a threshold value. In some implementations, the NE, the processor, and the method may further be configured to, capable of, or operable to receive, based on an SNR associated with the RACH preamble satisfying a threshold value, a Msg3 across two or more carriers of the set of carriers.

In some implementations, the signaling includes respective RACH configuration indices associated with the set of carriers that indicate one or more of a PRACH configuration index, a PRACH periodicity, a slot offset, or one or more PRACH time-domain occasions. In some implementations, the NE, the processor, and the method may further be configured to, capable of, or operable to receive one or more repetitions of the RACH preamble based on one or more additional RACH occasions, where the one or more additional RACH occasions are associated with one or more additional carriers of the set of carriers. In some implementations, the signaling includes one or more of a PRACH configuration index that indicates the set of RACH occasions, a preamble format associated with the RACH preamble, a zero correlation zone, or one or more power ramping parameters. In some implementations, respective carriers of the set of carriers are associated with a BWP identifier, and the signaling indicates the BWP identifier. In some implementations, the set of carriers are associated with the cell based on the set of carriers sharing one or more of a PCI, a cell identifier, a synchronization raster, a RACH configuration index, system information, or a radio frequency.

### BRIEF DESCRIPTION OF THE DRAWINGS

FIG. 1 illustrates an example of a wireless communications system in accordance with aspects of the present disclosure.

FIGS. 2 through 4 illustrate examples of resource diagrams, in accordance with aspects of the present disclosure.

FIG. 5 illustrates an example of a wireless communications system, in accordance with aspects of the present disclosure.

FIG. 6 illustrates an example of a signaling diagram, in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates a flowchart of a method performed by a UE in accordance with aspects of the present disclosure.

FIG. 11 illustrates a flowchart of a method performed by an NE in accordance with aspects of the present disclosure.

### DETAILED DESCRIPTION

In a wireless communications system, a UE and an NE (e.g., a base station, a gNB) may support transmission and reception of signaling, referred to as wireless communication. For example, an NE may transmit (e.g., send, broadcast) signaling to one or more UEs to configure time-frequency resources allocated for a random access procedure between the UEs and the NE. A UE may initiate the random access procedure to establish or reestablish a connection with the NE by transmitting a RACH preamble on (e.g., during) a configured time-frequency resource, referred to as a RACH occasion. In some examples, the NE may group multiple carriers, which may be examples of sets of frequency resources, that share one or more parameters in a single cell (e.g., a virtual cell). However, the NE may not account for the grouping of carriers into a single cell in the configured RACH occasions, leading to inefficient resource utilization for random access procedures. Additionally, or alternatively, the UE may be unable to select RACH occasions across the carriers in the single cell, which may result in higher power consumption and degraded performance due to increased random access failures.

As described herein, to improve resource utilization efficiency, as well as to reduce random access failures across multiple carriers in a single cell, an NE and a UE may implement RACH occasion configuration and selection that accounts for the grouping of carriers into a single cell. The NE may transmit signaling (e.g., system information, radio resource control (RRC) signaling) to a UE that indicates a set of RACH occasions spread (e.g., distributed) across multiple carriers in a single cell. The UE may select a RACH occasion from the set of RACH occasions according to a UE type of the UE (e.g., a reduced capability UE, a full capability UE), a radio frequency capability of the UE (e.g., a number of radio frequency chains, a power capability), or one or more measurements for the carriers (e.g., RSRP measurements, pathloss measurements). The UE may transmit a RACH preamble during the selected RACH occasion to initiate a random access procedure. The NE may receive the RACH preamble and may determine an identifier (e.g., an RA-RNTI) for an RAR according to one or more carriers on which the RACH preamble is received, thereby enabling the NE to respond to the UE on a corresponding carrier or carriers.

By performing the described techniques, a device (e.g., a UE and/or an NE) in a wireless communications system may provide for improved flexibility, reduced latency, and enhanced performance during random access procedures across multiple carriers. For example, the UE selecting from RACH occasions that are distributed across a set of carriers of a cell enables the UE to select an earliest available RACH occasion to reduce random access latency. Additionally, or alternatively, the UE may select a RACH occasion according to one or more measurements for the carriers, which improves random access success rates and reduces power consumption at the UE by preventing or reducing transmissions on carriers with channel conditions less than a threshold value.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings, is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

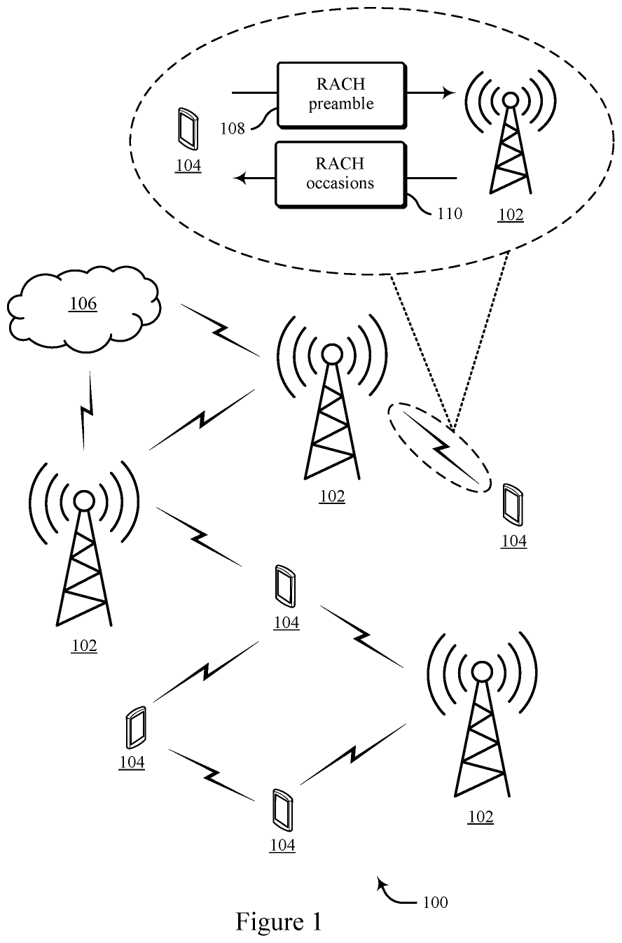

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be, or include, or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be movable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include, or may be referred to as, a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or a machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 Gigahertz (GHz)), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, the NEs 102 and the UEs 104 may consume energy to perform various operations (e.g., wireless communications, signal processing, data transmission, data reception). In some cases, the NEs 102 and the UEs 104 may support energy saving techniques to reduce power consumption, such as discontinuous transmission (DTX), discontinuous reception (DRX), or sleep modes. For example, an NE 102 and/or a UE 104 may enter an inactive state (e.g., low-power state, sleep state, idle state) if there is no downlink transmission or uplink reception, and may transition to an active state (e.g., may wake up) if transmission or reception is to be performed. An inactive state may refer to a power state in which a device reduces or suspends operation of one or more components to conserve energy. During a transition from an active state to an inactive state, the device may deactivate or power down various components, such as power amplifiers, radio frequency chains, baseband processing units, or other circuitry that is not utilized in the inactive state. For DTX, a device (e.g., the NE 102 or the UE 104) refrains from transmitting signals during periods with no data to transmit, providing for the device to reduce power consumption by deactivating or reducing power to transmitter components during inactive periods. For DRX, the device monitors for incoming signals during configured active periods and enters an inactive state during configured inactive periods, providing for the device to reduce power consumption by deactivating or reducing power to receiver components if reception is not expected.

Data traffic in the wireless communications system 100 may increase over time, such as by approximately 6.4 gigabytes (GB) per user per month. Operators of the wireless communications system 100 may implement energy-saving techniques due to the increased data traffic, rising overhead of spectrum (e.g., the range of radio frequencies allocated for wireless communication), capital investment, and ongoing RAN maintenance and upgrades, among other factors. In some cases, 5G use cases and the adoption of millimeter-wave (mm-Wave) frequencies, which operate in the frequency range of approximately 24 GHz to 100 GHz and enable high-bandwidth communication, utilize an increased numerical quantity of sites and antennas when compared with previous use cases (e.g., 4G, LTE). Additionally, or alternatively, as wireless communications systems (e.g., including the wireless communications system 100) implement 5G across industries and geographical areas, handling more advanced services and applications utilizing relatively high data rates (e.g., extended reality (XR) applications), networks become denser, use more antennas, larger bandwidths, and more frequency bands. The increased numerical quantity of sites and antennas, as well as the increased data rates, may lead to increased energy consumption and emissions. Thus, the wireless communications system 100 may implement network energy saving (e.g., energy saving at one or more NEs 102 or other network-related devices) to reduce environmental impact through decreased greenhouse gas emissions, as well as to achieve operational cost savings.

The RAN consumes a relatively high amount of energy (e.g., greater than a threshold amount of energy), such as from one or more active antenna units (AAUs), which integrate antenna elements with radio frequency components in a single unit. The power consumption of the RAN can be split into two portions, including a dynamic portion, which the network consumes when data transmission or reception occurs, and a static portion, which the network consumes continuously to maintain operation of the radio access devices, even when data transmission or reception does not occur. The wireless communications system 100 may implement the network energy savings techniques to achieve more efficient operation dynamically and/or semi-statically and finer granularity adaptation of transmissions and/or receptions in time, frequency, spatial, and power domains. The network energy savings techniques may support feedback from one or more UEs 104, UE assistance information, and/or information exchange or coordination over network interfaces.

In some examples, the network energy savings techniques include configuring common channels within an active duration (e.g., time) of a cell. A cell may refer to a logical entity associated with an NE 102 that provides wireless communication services to one or more UEs 104 within a geographic coverage area. The cell may be associated with one or more defined (e.g., configured) radio resources, including time resources, frequency resources, and/or spatial resources (e.g., beams), that the NE 102 manages for communication with the UEs 104. If the NE 102 activates a network energy saving configuration for a cell, then common channels may be transmitted within an active time of the NE 102 to save power. For example, if an NE 102 activates the network energy saving configuration, such as an idle mode cell discontinuous transmission/discontinuous reception (DTX/DRX) configuration, then the common channels are to be transmitted within the active time of the NE 102 to save power. Otherwise, the NE 102 may consolidate or cluster the common channel frame to provide for the NE 102 to enter an inactive state (e.g., a deep sleep state, a sleep state) as part of the network energy savings.

The common channels may include channels and/or signals that carry information accessible to multiple UEs 104, such as an SSB, an SIB, a paging channel, and/or a PRACH. The SSB may include a primary synchronization signal (PSS), a secondary synchronization signal (SSS), and a physical broadcast channel (PBCH), which enable UEs 104 to synchronize with the NE 102 and obtain initial system information. The SIB may include system information block type 1 (SIB1), which provides system information for initial access, as well as other SIB types that provide additional configuration information. The paging channel may include one or more POs, which are examples of defined time-frequency resources during which the NE 102 transmits paging messages to notify UEs 104 of incoming signaling (e.g., data and/or control information). The PRACH may include one or more RACH occasions during which UEs 104 transmit RACH preambles to initiate random access procedures. In some cases, the common channels may be clustered in the time domain to improve power efficiency at the NE 102 and/or the UE 104. Clustering refers to grouping transmissions of common channels into concentrated time periods, followed by inactive durations during which the NE 102 and/or the UE 104 may enter a low-power state. In some cases, the clustering may be performed on a per-beam basis, where common channels associated with a single beam (e.g., SSB, SIB, RACH occasion, and paging occasion (PO) for a beam) are grouped together in time before proceeding to common channels for a next beam. Additionally, or alternatively, the clustering may be performed on a per-burst basis, where common channels of the same type across multiple beams are grouped together (e.g., an SSB burst including SSBs for multiple beams, followed by a SIB burst including SIBs for multiple beams, followed by a RACH burst including RACH occasions for multiple beams). In some examples, the clustering may be performed using a hierarchical approach with beam groups, where beams associated with similar spatial directions are grouped together, and common channels for each beam group are clustered in time before proceeding to a next beam group.

In some examples, a UE 104 and/or an NE 102 may perform a random access procedure to establish or reestablish a connection between the UE 104 and the NE 102. For example, the UE 104 and/or the NE 102 may initiate the random access procedure for initial access, handover between cells, transition from an idle or inactive state to a connected state, recovery from a radio link failure, scheduling request when no dedicated scheduling request resources are available, beam failure recovery, and/or other procedures, including positioning or timing advance adjustment. The random access procedure may include multiple messages exchanged between the UE 104 and the NE 102. In a four-step random access procedure, the UE 104 transmits a RACH preamble (e.g., Msg1) on a RACH occasion, and the NE 102 responds with an RAR (e.g., Msg2) that includes timing advance information, a grant (e.g., uplink grant) for subsequent transmission, and a temporary cell-RNTI (C-RNTI). The timing advance information indicates a timing adjustment value that the UE 104 applies to align uplink transmissions with the timing of the NE 102, compensating for propagation delay between the UE 104 and the NE 102. The grant indicates time-frequency resources allocated for the UE 104 to transmit a subsequent message in the random access procedure. The temporary C-RNTI is an identifier assigned to the UE 104 for use during the random access procedure.

The UE 104 transmits a scheduled transmission (e.g., Msg3) using the grant provided in the RAR. For example, the UE 104 transmits the Msg3 on one or more time-frequency resources allocated by the grant. The Msg3 may include a connection request, identity information, and/or other control information depending on the purpose of the random access procedure. The NE 102 responds with a contention resolution message (e.g., Msg4) that resolves contention between UEs 104 that may have transmitted a same preamble on a same RACH occasion. For example, the Msg4 includes an identity of the UE 104 that successfully completed the random access procedure, and each UE 104 that transmitted a RACH preamble compares the identity in the Msg4 with an identity of the UE 104 to determine whether the contention resolution was successful. In a two-step random access procedure, the UE 104 combines the RACH preamble and the scheduled transmission into a single message (e.g., MsgA), and the NE 102 responds with a combined RAR and contention resolution message (e.g., MsgB).

The UE 104 may determine a RACH occasion to use for transmitting the RACH preamble using a mapping between SSBs and RACH occasions. For example, an NE 102 and/or a UE 104 may implement an SSB-to-RACH occasion mapping that defines a relationship between SSB indices and the RACH occasions on which UEs 104 may transmit RACH preambles. The UE 104 may detect one or more SSBs transmitted by the NE 102, where each SSB is associated with an SSB index that identifies the beam direction of the SSB transmission. The UE 104 may perform one or more measurements on the detected SSBs to select a beam with a corresponding SSB index for communication. For example, the UE 104 may perform one or more of RSRP measurements, reference signal received quality (RSRQ) measurements, and/or signal-to-interference-plus-noise ratio (SINR) measurements, among other example measurements, on the detected SSBs. The RSRP measurement indicates the average power of resource elements carrying the SSB, providing an indication of signal strength for each beam. The RSRQ measurement indicates the quality of the received signal relative to interference and noise, providing an indication of signal quality for each beam. The SINR measurement indicates the ratio of signal power to interference and noise power, providing an indication of the channel conditions for each beam. The UE 104 may compare the measurements for each of the SSBs to select an SSB index corresponding to a beam that has a highest quality among the detected beams, such as a beam with a highest RSRP value, a highest RSRQ value, and/or a highest SINR value. In some cases, the UE 104 may select the beam using a combination of measurements, such as selecting a beam that satisfies threshold values for multiple measurement types.

The UE 104 may use the mapping to determine one or more RACH occasions mapped to the selected SSB index. For example, the UE 104 may receive configuration information from the NE 102 that indicates the SSB-to-RACH occasion mapping, such as via system information (e.g., SIB1) or dedicated RRC signaling. The configuration information may indicate parameters, including a numerical quantity of SSBs mapped to each RACH occasion, a numerical quantity of RACH occasions in the frequency domain, and/or a numerical quantity of RACH occasions in the time domain. The UE 104 may use the selected SSB index and the configured mapping parameters to calculate a RACH occasion or set of RACH occasions for the selected SSB index by applying the mapping rules in a defined order, such as first mapping preambles within a RACH occasion, then mapping frequency domain RACH occasions, and then mapping time domain RACH occasions to the SSB indices. The UE 104 transmits the RACH preamble on the determined RACH occasions (e.g., indicated by the mapping). The NE 102 receives the RACH preamble on the RACH occasion and uses the SSB-to-RACH occasion mapping to determine the beam direction (e.g., and corresponding SSB index) from which the UE 104 transmitted the RACH preamble according to the RACH occasion on which the preamble was received.

The SSB-RACH occasion association mapping configuration may follow various rules for mapping RACH preambles and RACH occasions to SSBs. In some examples, the rules may include the NE 102 mapping RACH preambles within RACH occasions to SSBs, then mapping frequency domain RACH occasions to the SSBs, and finally mapping the time domain RACH occasions to SSBs. The mapping may proceed in increasing order of preamble indexes within a single RACH occasion. Additionally, or alternatively, the mapping proceeds in increasing order of frequency resource indexes for frequency multiplexed RACH occasions. Additionally, or alternatively, the mapping proceeds in increasing order of time resource indexes for time multiplexed RACH occasions within a PRACH slot. Additionally, or alternatively, the mapping proceeds in increasing order of indexes for PRACH slots.

In some examples, one or more parameters may define the mapping between SSB and RACH occasions. For example, two RRC parameters define the mapping between SSB and RACH occasions. The first RRC parameter, msg1-FDM, may have a value from a set (e.g., 1, 2, 4, 8). The second RRC parameter, ssb-perRACH-OccasionAndCB-PreamblesPerSSB, may have a value from a different set (e.g., ⅛, ¼, ½, 1, 2, 4, 8, 16). The msg1-FDM parameter indicates how many RACH occasions the NE 102 allocates in the frequency domain (e.g., for frequency division multiplexing (FDM)) at the same location in the time domain. The ssb-perRACH-OccasionAndCB-PreamblesPerSSB parameter indicates how many SSBs the NE 102 can map to one RACH occasion and how many preamble indexes the NE 102 can map to a single SSB. The ssb-perRACH-OccasionAndCB-PreamblesPerSSB parameter includes multiple portions (e.g., a CHOICE portion and an ENUMERATED portion). The CHOICE portion conveys information about a numerical quantity of SSBs per RACH occasion, where a value of oneEighth corresponds to one SSB associated with 8 RACH occasions, a value of oneFourth corresponds to one SSB associated with 4 RACH occasions, and so on. The ENUMERATED portion indicates a numerical quantity of contention-based preambles per SSB, where a value of n4 corresponds to 4 contention-based preambles per SSB, a value of n8 corresponds to 8 contention-based preambles per SSB, and so on.

Contention-based random access refers to a random access procedure in which multiple UEs 104 may select the same preamble, potentially causing collisions that the NE 102 resolves through subsequent messaging. The total number of contention-based preambles in a RACH occasion equals CB-preambles-per-SSB multiplied by max(1, SSB-per-rach-occasion), where a value of SSB-per-rach-occasion may be configured and/or defined. Various values of the ssb-perRACH-OccasionAndCB-PreamblesPerSSB parameter may indicate different numerical quantities of SSBs associated with a RACH occasion. For example, a value of 4 may correspond to 4 SSBs associated with a RACH occasion. In some cases, the msg1-FDM parameter may indicate a number of PRACH transmission occasions that the network FDMs in one time instance. For example, the msg1-FDM parameter may have possible values of 1, 2, 4, or 8.

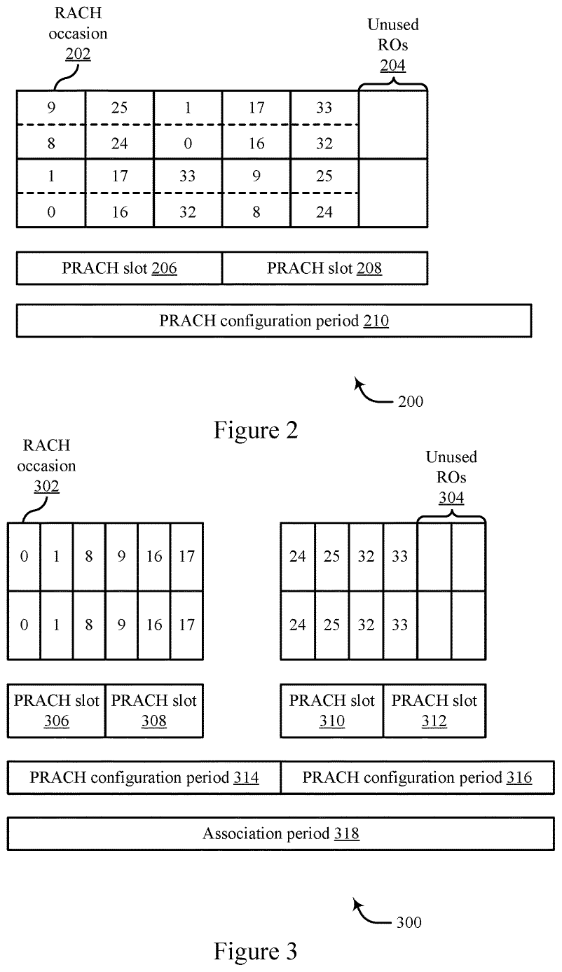

In addition to the RRC parameters, various numerical quantities of preambles may be available. In some cases, such as 5G NR, a total number of available preambles may equal 64. However, the actual preamble availability may depend on a zero correlation zone configuration and a root sequence index. The zero correlation zone may refer to a region in the time-frequency domain where different preamble sequences maintain orthogonality, enabling a receiver to distinguish between the preamble sequences. The root sequence index may indicate a base Zadoff-Chu sequence from which the NE 102 derives the preambles. In some examples, the NE 102 may associate SSBs (e.g., synchronization signal/PBCH (SS/PBCH) blocks) with RACH occasions using the RRC parameters and mapping rules, which are described in further detail with respect to FIGS. 2 and 3.

In some wireless communications systems, an NE 102 may configure multiple carriers to operate within a single cell, which may be referred to as a virtual cell. A virtual cell may include a set of carriers that share common cell-level parameters and identifiers. For example, the carriers within the virtual cell may share one or more of a physical cell identifier (PCI), a cell identifier, a synchronization raster, system information, radio frequency, and/or other cell-level configuration parameters. The PCI is a physical layer identifier that distinguishes cells within a RAN, and is used by UEs 104 to identify and synchronize with a cell during initial access and mobility procedures. The cell identifier is a higher-layer identifier that uniquely identifies a cell within the network and may be used for cell selection, reselection, and handover procedures. The synchronization raster defines the frequency locations at which UEs 104 search for SSBs during initial cell search, enabling UEs 104 to locate and synchronize with cells operating on different frequency bands. System information includes broadcast information transmitted by the NE 102 that provides configuration parameters for accessing and operating within the cell, such as access barring information, RACH configuration, and paging configuration. The radio frequency refers to the carrier frequency or frequencies on which the cell operates for uplink and downlink transmissions. As used herein, the terms “single cell” and “virtual cell” may be used interchangeably to refer to a cell configuration in which multiple carriers are associated with the cell and share one or more common parameters.

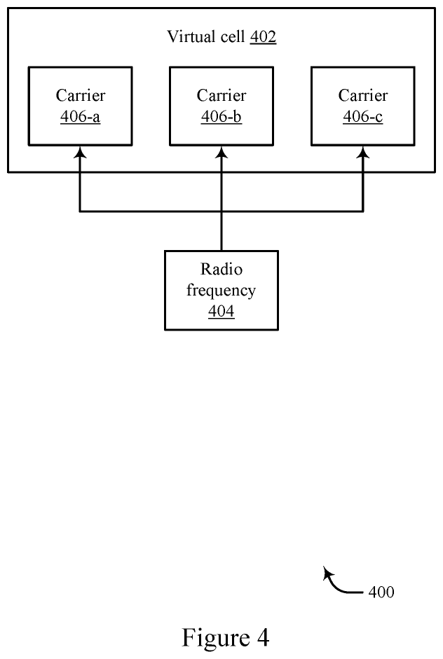

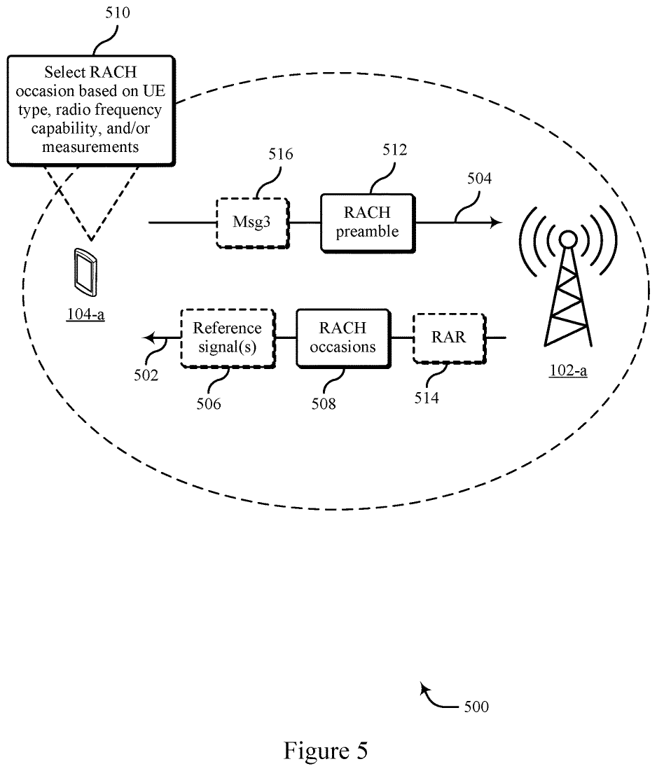

In some examples, the carriers within the virtual cell may be referred to as fragmented carriers or carriers and may represent portions of spectrum (e.g., a range of radio frequencies allocated for wireless communications) that are distributed across different frequency locations, rather than occupying a contiguous frequency band. For example, the carriers may enable the NE 102 to aggregate available spectrum resources across multiple frequency bands or non-contiguous portions of a frequency band to increase overall bandwidth and capacity for the cell, which is described in further detail with respect to FIG. 4. By grouping multiple carriers into a single cell, the NE 102 may reduce signaling overhead for managing separate cells for each carrier and may simplify mobility procedures for UEs 104 operating across the carriers. In some examples, the carriers within the virtual cell may span different frequency bands or different portions of a same frequency band. For example, the virtual cell may include carriers in FR1 and/or FR2, enabling the NE 102 to leverage different propagation characteristics and bandwidth availability across the frequency ranges. The carriers may have different bandwidths, subcarrier spacings, and/or numerologies depending on the frequency band and deployment scenario.

The NE 102 may configure the carriers with a common SSB configuration or with separate SSB configurations for each carrier, depending on the deployment criterion. An SSB configuration may include parameters, such as SSB periodicity, SSB time-domain positions, and/or SSB frequency-domain positions, that define when and where the NE 102 transmits SSBs on each carrier. In some cases, the NE 102 may configure a common SSB configuration if the carriers share a synchronization raster, enabling the UE 104 to perform cell search and synchronization procedures using a single set of SSB parameters across the carriers. In some other cases, the NE 102 may configure separate SSB configurations if the carriers have different frequency ranges or deployment scenarios, enabling the NE 102 to select SSB transmission parameters for each carrier independently.

The UE 104 may access the virtual cell by detecting SSBs transmitted on one or more of the carriers and performing initial access procedures. The initial access procedures may include, but are not limited to, cell search, synchronization, and/or system information acquisition. During cell search, the UE 104 scans for SSBs on the synchronization raster to detect cells operating within the frequency bands supported by the UE 104. The UE 104 may perform time and frequency synchronization using the PSS and SSS within the detected SSBs, enabling the UE 104 to align a timing and frequency with the NE 102. The UE 104 may decode the PBCH within the SSB to obtain a master information block (MIB), which provides parameters for accessing the cell, including system frame number (SFN) information and configuration for receiving SIB1. The UE 104 may receive SIB1, which includes cell access information, cell selection parameters, and scheduling information for other SIBs. Once the UE 104 receives the SIB1, the UE 104 may initiate a random access procedure to establish a connection with the NE 102 by transmitting a RACH preamble on a configured RACH occasion.

In some examples, the UE 104 may receive signaling (e.g., SIB1 and/or RRC signaling) that indicates a configuration of the multiple carriers within the virtual cell, including carrier frequencies, bandwidths, and/or RACH occasion configurations for each carrier. A RACH occasion configuration defines one or more time-frequency resources and associated parameters that the NE 102 allocates for UEs 104 to transmit RACH preambles during random access procedures. For example, the parameters may include, but are not limited to, a PRACH configuration index that indicates a periodicity and timing of RACH occasions within a frame structure, a preamble format that indicates a structure and duration of RACH preambles, frequency domain parameters that indicate a location and bandwidth of RACH occasions within a carrier, and/or power control parameters that indicate the transmission power for RACH preambles. The RACH occasion configuration may also include parameters for the SSB-to-RACH occasion mapping, enabling the UE 104 to determine RACH occasions that correspond to detected SSBs. In the context of a virtual cell with multiple carriers, the RACH occasion configuration may indicate RACH occasions on each carrier, including carrier-specific timing offsets, frequency locations, and preamble allocations.

In some cases, the RACH occasion configurations may not account for grouping multiple carriers into a single cell (e.g., for a virtual cell). For example, the NE 102 may provide a separate RACH configuration for each carrier, which may result in inefficient resource utilization, as RACH occasions on different carriers may not be coordinated for the virtual cell configuration. Additionally, or alternatively, the UE 104 may be limited to selecting RACH occasions on the single carrier indicated by the RACH configuration, which may increase random access latency if the earliest available RACH occasion is on a different carrier within the virtual cell. Additionally, or alternatively, the UE 104 may be unable to select RACH occasions according to channel conditions across the carriers, which may result in random access failures if the UE 104 attempts random access on a carrier with poor channel conditions (e.g., channel conditions below a threshold quality).

According to implementations, one or more of the NEs 102 and the UEs 104 are operable to implement various aspects of the techniques described with reference to the present disclosure. An NE 102 (e.g., a base station, gNB) transmits signaling to a UE 104 that indicates a set of RACH occasions 110 for a random access procedure. The RACH occasions 110 represent time-frequency resources distributed across multiple carriers within a single cell (e.g., a virtual cell), enabling the UE 104 to select from RACH occasions 110 on different carriers according to UE capabilities and channel conditions. For example, the UE 104 selects a RACH occasion 110 from the set of RACH occasions 110 according to at least one of a UE type of the UE 104, a radio frequency capability of the UE 104, and/or one or more measurements performed on the set of carriers. The UE 104 transmits a RACH preamble 108 during the selected RACH occasion 110 to initiate the random access procedure. The NE 102 receives the RACH preamble 108 during the RACH occasion 110 and determines an identifier for an RAR using one or more of a time index indicating a transmission time of the RACH preamble 108, a frequency index indicating a frequency location of the RACH preamble 108, a carrier index identifying the carrier, or a BWP identifier identifying the carrier. The NE 102 transmits the RAR to the UE 104 using the identifier, enabling the UE 104 to complete the random access procedure on the selected carrier or on an additional carrier indicated by the NE 102.

Reference is made herein to communicating data or information, such as signaling, communication resources, and/or communications that are transmitted or received between devices. It is to be appreciated that other terms may be used interchangeably with communicating, such as signaling, transmitting, receiving, outputting, forwarding, retrieving, obtaining, and so forth.

FIG. 2 illustrates an example of a resource diagram 200 in accordance with aspects of the present disclosure. In some examples, the resource diagram 200 implements or is implemented by aspects of the wireless communications system 100. For example, the resource diagram 200 may be implemented by one or more UEs and/or NEs, which may be an example of NEs 102 and UEs 104, as described with reference to FIG. 1. The resource diagram 200 illustrates an example of SSB-to-RACH occasion mapping with multiple SSBs mapped to each RACH occasion within a PRACH configuration period.

The resource diagram 200 includes RACH occasions 202 arranged in time and frequency domains, such as ten RACH occasions 202 and two unused RACH occasions 204. The RACH occasions 202 include time-frequency resources allocated for RACH transmissions, as described with reference to FIG. 1. For example, the RACH occasions 202 may be used by UEs to transmit RACH preambles during random access procedures. A UE may select an SSB index based on beam measurements and determine a corresponding RACH occasion 202 using the SSB-to-RACH occasion mapping. The UE may transmit a RACH preamble on the determined RACH occasion 202 to initiate communication with an NE. The NE may monitor the RACH occasions 202 to detect RACH preambles transmitted by UEs and may use the SSB-to-RACH occasion mapping to determine the beam direction associated with a received RACH preamble based on the RACH occasion 202 on which the preamble was received.

In some examples, the resource diagram 200 includes one or more (e.g., two) unused RACH occasions 204, which represent RACH occasions that are not mapped to any SSB indices. The resource diagram 200 includes one or more PRACH slots, such as PRACH slot 206 and PRACH slot 208. A PRACH slot may be an example of time-domain resources (e.g., in units of slots) allocated for PRACH transmissions. The PRACH slot 206 and PRACH slot 208 may be within a PRACH configuration period 210, which may be greater than a duration of the PRACH slot 206 and the PRACH slot 208. The PRACH configuration period 210 is a time period over which PRACH resources are configured. For example, a number of SSBs indicated to the UE 104 as being transmitted may equal ten (e.g., NSSB Tx=10). The transmitted SSBs may have indices {0, 1, 8, 9, 16, 17, 24, 25, 32, 33}. A number of SSBs mapped to one RACH occasion may equal two (e.g., N=2). A number of FDMed RACH occasions may equal two. A number of time-domain RACH occasions in one PRACH slot may equal three. A number of PRACH slots in one PRACH configuration period may equal two. The resource diagram 200 displays numerical values representing SSB indices mapped to respective RACH occasions 202, with values including 0, 1, 8, 9, 16, 17, 24, 25, 32, and 33 distributed across the RACH occasions 202.

FIG. 3 illustrates an example of a resource diagram 300 in accordance with aspects of the present disclosure. In some examples, the resource diagram 300 implements or is implemented by aspects of the wireless communications system 100 and/or the resource diagram 200. For example, the resource diagram 300 may be implemented by one or more UEs and/or NEs, which may be an example of NEs 102 and UEs 104, as described with reference to FIG. 1. The resource diagram 300 illustrates an example of an SSB-to-RACH occasion mapping with a different SSB-to-RACH occasion ratio than the resource diagram 200.

The resource diagram 300 includes RACH occasions 302 and unused RACH occasions 304 in time and frequency domains, such as twenty RACH occasions 302 and four unused RACH occasions 304. The RACH occasions 302 include time-frequency resources allocated for RACH transmissions, as described with reference to FIG. 1. For example, the RACH occasions 302 may be used by UEs to transmit RACH preambles during random access procedures. A UE may select an SSB index based on beam measurements and determine a corresponding RACH occasion 302 using the SSB-to-RACH occasion mapping. The UE may transmit a RACH preamble on the determined RACH occasion 302 to initiate communication with an NE. The NE may monitor the RACH occasions 302 to detect RACH preambles transmitted by UEs and may use the SSB-to-RACH occasion mapping to determine the beam direction from which a UE transmitted the RACH preamble based on the RACH occasion 302 on which the preamble was received.

In some examples, the resource diagram 300 includes one or more unused RACH occasions 304, which represent RACH occasions that are not mapped to any SSB indices. The resource diagram 300 includes one or more PRACH slots, such as the PRACH slot 306, PRACH slot 308, PRACH slot 310, and PRACH slot 312. A PRACH slot may be an example of time-domain resources (e.g., in units of slots) allocated for PRACH transmissions. The PRACH slot 306 and PRACH slot 308 may be within a PRACH configuration period 314, and the PRACH slot 310 and PRACH slot 312 may be within a PRACH configuration period 316. The PRACH configuration period 314 and PRACH configuration period 316 together form an association period 318. The association period 318 is a time period over which SSB indices are associated with RACH occasions across multiple PRACH configuration periods. For example, a number of SSBs indicated to the UE 104 as being transmitted may equal ten (e.g., NSSB Tx=10). The transmitted SSBs may have indices {0, 1, 8, 9, 16, 17, 24, 25, 32, 33}. An NE may map each SSB to two RACH occasions (e.g., N=½). A number of FDMed RACH occasions may equal two. A number of time-domain RACH occasions in one PRACH slot may equal three. A number of PRACH slots in one PRACH configuration period may equal two. The resource diagram 300 displays numerical values representing SSB indices mapped to respective RACH occasions 302, with values including 0, 1, 8, 9, 16, 17, 24, 25, 32, and 33 distributed across the RACH occasions 302.

FIG. 4 illustrates an example of a resource diagram 400 in accordance with aspects of the present disclosure. In some examples, the resource diagram 400 implements or is implemented by aspects of the wireless communications system 100, the resource diagram 200, and/or the resource diagram 300. For example, the resource diagram 400 may be implemented by one or more UEs and/or NEs, which may be an example of NEs 102 and UEs 104, as described with reference to FIG. 1. The resource diagram 400 illustrates an example of a virtual cell (e.g., single cell) configuration with multiple carriers.

The resource diagram 400 includes a virtual cell 402 that spans a radio frequency 404 across a set of one or more carriers, including a carrier 406-a, a carrier 406-b, and a carrier 406-c. Although the resource diagram 400 illustrates the virtual cell 402 spanning three carriers, the virtual cell 402 may span any numerical quantity of carriers. The carriers may be examples of, or referred to as, component carriers (e.g., carriers that an NE aggregates together for carrier aggregation) or fragmented carriers, as described with reference to FIG. 1. For example, the carrier 406-a, carrier 406-b, and carrier 406-c represent fragmented (e.g., not adjacent in frequency) carriers that a UE perceives as a single logical cell.

In some examples, the carriers that form the virtual cell 402 share common parameters. For example, the carrier 406-a, carrier 406-b, and carrier 406-c may share a same PCI, a same cell identifier, a same synchronization raster, a same RACH configuration index, same system information (e.g., SIB1), and/or a same radio frequency 404. From a UE perspective, the virtual cell 402 appears as one logical serving cell with multiple physical uplink and downlink carriers. The UE 104 may access the virtual cell 402 by detecting SSBs transmitted on one or more of the carriers and performing initial access procedures. From a radio frequency perspective, a single radio frequency 404 may span across the carriers, or a first radio frequency may span across a first subset of carriers, while a second (e.g., another, a different) radio frequency spans across a second subset of carriers. In some cases, a RACH resource may indicate the support of carriers or a shared radio frequency chain by a UE. For example, a UE may select a RACH resource from a same uplink carrier in which a downlink synchronization signal is transmitted if one carrier is supported at the UE. Additionally, or alternatively, a UE may select another carrier different from that of the downlink synchronization signal to indicate support of multiple carriers.

In some examples, an NE may broadcast a carrier barring status for some of the fragmented carriers in remaining minimum system information (RMSI) depending on device type. The carrier barring status enables the NE 102 to limit access to carriers according to UE capabilities or network policies. For example, the NE 102 may bar reduced capability UEs from accessing wider bandwidth carriers that exceed the bandwidth capabilities of the reduced capability UEs, while permitting full capability UEs to access the wider bandwidth carriers. Additionally, or alternatively, the NE 102 may bar one or more UE types (e.g., device types) from accessing carriers that are reserved for other UE types or for services. The NE may indicate the carrier barring status per carrier or per group of carriers.

The resource diagram 400 illustrates RACH configuration across the carriers within the virtual cell 402. The NE may configure a same RACH configuration index and RACH resources across the carriers or a subset of the carriers within the virtual cell 402. In some examples, the NE may configure one or more of the carriers as a RACH-less carrier. A RACH-less carrier refers to a carrier on which the NE does not configure RACH occasions, such that UEs do not transmit RACH preambles on the RACH-less carrier. For example, the NE may configure the carrier 406-a and the carrier 406-b with RACH occasions, while configuring the carrier 406-c as a RACH-less carrier. A UE may perform initial access or random access procedures on the carrier 406-a or the carrier 406-b, and after establishing a connection, the NE may schedule the UE for data transmission on the carrier 406-c.

The NE may FDM RACH occasions in a same time slot, where the NE configures each FDMed resource in each carrier within the virtual cell 402. FDM refers to a multiplexing technique in which multiple signals are transmitted simultaneously by allocating each signal to a different frequency band or subcarrier within the available spectrum. For example, the NE may configure multiple RACH occasions at a same time-domain location (e.g., a same slot or a same set of symbols), and at different frequency-domain locations across the carriers within the virtual cell 402. The FDM configuration may increase the number of available RACH occasions for UEs to select from during a given time period, which may reduce random access latency and collision probability.

The configuration of RACH occasions, random access preamble identifiers (RAPIDs), preambles, and RARs may span across the carriers. For example, the NE may configure RACH occasions on the carrier 406-a at a first frequency location, RACH occasions on the carrier 406-b at a second frequency location, and RACH occasions on the carrier 406-c at a third frequency location, where the RACH occasions on the carrier 406-a, carrier 406-b, and carrier 406-c may occur during a same time slot. A RAPID refers to an identifier that uniquely identifies a RACH preamble transmitted by a UE within a RACH occasion, enabling the NE to associate an RAR with the corresponding RACH preamble.

A UE may select RACH resources across the fragmented carriers according to a UE type and radio frequency capability. For example, the UE may select a RACH occasion on the carrier 406-a, carrier 406-b, or carrier 406-c depending on whether the UE is an IoT device, an XR device, or a mobile broadband (MBB) device. An IoT device refers to a UE designed for machine-type communication applications, which may have reduced capabilities when compared with other UE types (e.g., limited bandwidth support, reduced transmit power, or a single radio frequency chain). An XR device refers to a UE designed for XR applications, including virtual reality, augmented reality, and mixed reality, which may utilize high data rates, low latency, and support for wider bandwidth carriers. An MBB device refers to a UE designed for MBB applications, such as smartphones or tablets, which may support full bandwidth capabilities, multiple radio frequency chains, and/or high data rate transmissions. Additionally, or alternatively, the UE may select a RACH occasion in response to a number (e.g., numerical quantity, amount) of radio frequency chains that the UE supports or a power capability of the UE 104.

The UE 104 may monitor for reception of an RAR (e.g., Msg2) using an identifier that includes carrier context information. For example, the identifier may be an RA-RNTI that the UE 104 derives (e.g., identifies, computes, determines, obtains), which is described in further detail with respect to FIG. 5. Additionally, or alternatively, the identifier may include one or more of a temporary C-RNTI or another type of identifier that enables the UE to monitor for and receive the RAR from the NE. The UE 104 may monitor a downlink control channel, such as a physical downlink control channel (PDCCH), for the RAR using the computed RA-RNTI during a configured RAR window following transmission of the RACH preamble. The UE 104 may select one of the carriers for transmission of a third message (e.g., Msg3) in accordance with the RAR or in accordance with an uplink grant that the RAR includes.

FIG. 5 illustrates an example of a wireless communications system 500 in accordance with aspects of the present disclosure. In some examples, the wireless communications system 500 implements or is implemented by aspects of the wireless communications system 100, the resource diagram 200, the resource diagram 300, and/or the resource diagram 400. For example, the wireless communications system 500 may be implemented by one or more UEs and/or NEs, which may be examples of NEs 102 and UEs 104, as described with reference to FIG. 1. The wireless communications system 500 illustrates a random access procedure across multiple carriers of a virtual cell. In some examples, the UE 104-a and the NE 102-a may exchange signaling with one another. For example, the NE 102-a may transmit signaling to the UE 104-a via a downlink communications link 502, which may be an example of a communications link as described with reference to FIG. 1. In some other examples, the UE 104-a may transmit signaling to the NE 102-a via an uplink communications link 504, which may be an example of a communications link as described with reference to FIG. 1. The signaling between the UE 104-a and the NE 102-a may include control signaling and/or data transmissions.

In some cases, the NE 102-a transmits one or more reference signals 506 to the UE 104-a via the downlink communications link 502. The reference signals 506 may include, but are not limited to, SSB signals, channel state information reference signals (CSI-RS), or other reference signals that enable the UE 104-a to perform channel measurements. In some examples, the NE 102-a transmits the reference signals 506 on one or more carriers within the virtual cell. For example, the NE 102-a may transmit the reference signals 506 on each carrier of the carriers, enabling the UE 104-a to perform measurements for respective carriers independently. In some other examples, multiple NEs may transmit reference signals 506 to the UE 104-a, such as if the UE 104-a is located in a coverage area served by the NEs. The NE 102-a and/or NEs may transmit the reference signals 506 periodically according to a configured periodicity or aperiodically in response to a trigger condition.

The UE 104-a uses the reference signals 506 to perform measurements for respective carriers of the carriers within the virtual cell. The measurements may include, but are not limited to, SSB RSRP measurements, RSRP measurements per carrier or BWP, and/or uplink pathloss estimations. For example, the UE 104-a may use the SSB signals to measure RSRP by determining the average power of resource elements carrying the SSB on each carrier. Additionally, or alternatively, the UE 104-a may use the CSI-RS to perform RSRP measurements per carrier or per BWP. The UE 104-a may estimate uplink pathloss for each carrier based on the downlink reference signal measurements and a configured pathloss reference. The UE 104-a may compare the measurements against one or more threshold values to identify carriers that satisfy a channel quality criterion for random access. For example, the UE 104-a may compare RSRP measurements to a configured RSRP threshold to determine which carriers have sufficient signal strength for successful RACH preamble transmission, or the UE 104-a may compare pathloss estimations to a pathloss threshold to identify carriers on which the UE 104-a can transmit within a power criterion.

The NE 102-a transmits signaling that configures one or more RACH occasions 508 to the UE 104-a. The signaling may include system information (e.g., SIB1) or dedicated RRC signaling that indicates the set of RACH occasions 508 spread across the carriers of the virtual cell. In some cases, the signaling may indicate a same PRACH configuration index across the carriers in the virtual cell, a same preamble format, a same zero correlation zone, and/or same power ramping parameters. A PRACH configuration index refers to a parameter that indicates a periodicity and timing of RACH occasions within a frame structure, enabling the UE 104-a to determine when RACH occasions occur on each carrier. A preamble format refers to a parameter that defines the structure and duration of RACH preambles, including the sequence length, cyclic prefix duration, and guard period. A zero correlation zone refers to a parameter that defines a region in the time-frequency domain in which different preamble sequences maintain orthogonality, enabling the NE 102-a to distinguish between preamble sequences transmitted by different UEs. Power ramping parameters indicate transmission power adjustments for RACH preambles, including an initial preamble power, a power ramping step size, and a maximum preamble transmission power.

In some cases, the NE 102-a FDMs the RACH occasions 508 across carriers, where the NE 102-a configures each FDM resource in each carrier within the virtual cell. For example, frequency-domain RACH resources may be separated per carrier. The RACH occasions 508 occur in a same slot timing across the carriers. In some examples, the NE 102-a configures each carrier as a BWP within the virtual cell. A BWP may correspond to a contiguous set of physical resource blocks on a carrier, and each fragment of a carrier may correspond to a respective BWP. The NE 102-a may assign a BWP identifier to each BWP, where the BWP identifier is an index value that uniquely identifies the BWP among the set of BWPs configured for the virtual cell. The NE 102-a may configure the BWP identifiers across the carriers of the virtual cell to enable the UE 104-a to identify and select RACH occasions for carriers using the BWP identifiers.

In some cases, the RACH occasions 508 in the signaling may be ordered with an increasing number of FDMed RACH resources and then with an increasing number of time division multiplexed (TDMed) RACH resources. TDMed RACH resources refer to RACH occasions 508 that are allocated at different time positions, such as different symbols or slots, enabling RACH preamble transmissions to occur sequentially in time. In some other cases, the NE 102-a numbers the RACH occasions 508 with an increased number of TDMed resources and then with an increased number of FDMed RACH resources across carriers.

At 510, the UE 104-a selects a RACH occasion based on at least one of a UE type of the UE 104-a, a radio frequency capability of the UE 104-a, and/or one or more measurements for the set of carriers. The UE type may include an IoT device, an XR device, or an MBB device, where each UE type may have different bandwidth capabilities, power characteristics, and/or radio frequency chain configurations that impact RACH occasion selection. For UE type selection, an IoT device selects a lowest frequency carrier or a narrower bandwidth carrier, while an XR device or MBB device selects a carrier including a widest bandwidth.

The radio frequency capability of the UE 104-a may impact RACH occasion selection based on the hardware configuration and power characteristics of the UE 104-a. For example, the UE 104-a may have a single radio frequency chain, such that the UE 104-a includes one transmitter chain and one receiver chain (e.g., the UE 104-a transmits and receives on one carrier at a time). A UE 104-a with a single radio frequency chain may select a RACH occasion on a single carrier without simultaneously monitoring or transmitting on multiple carriers. In some other examples, the UE 104-a may have a set of radio frequency chains (e.g., multiple radio frequency chains), such that the UE 104-a includes multiple transmitter chains and multiple receiver chains (e.g., the UE 104-a is capable of simultaneously transmitting and receiving on multiple carriers or performing carrier aggregation). A UE 104-a with multiple radio frequency chains may select a RACH occasion on a carrier that maximizes channel conditions, such as a carrier with a highest RSRP. In some cases, the UE 104-a may have a reduced power capability with a lower maximum transmit power compared with other UE types. For example, the UE 104-a may have a limited battery capacity, device form factor limitations, or regulatory restrictions. A UE 104-a with a reduced power capability may select a RACH occasion on a carrier with a lowest pathloss to compensate for the limited transmit power and to increase the likelihood of successful RACH preamble reception at the NE 102-a.

In some examples, the UE 104-a may support multi-carrier uplink based on the UE 104-a having a radio frequency capability that includes multiple radio frequency chains (e.g., multiple transmit chains), a power capability that supports simultaneous transmission on multiple carriers, or a UE type that indicates support for carrier aggregation in the uplink direction. If the UE 104-a supports multi-carrier uplink, then the UE 104-a selects a carrier with a maximum uplink link budget margin. The uplink link budget margin may refer to a difference between a maximum transmit power of the UE 104-a and an estimated transmit power for achieving a target signal quality at the NE 102-a, where a larger link budget margin indicates that the UE 104-a has additional power headroom available for uplink transmissions on the carrier. The UE 104-a may determine the uplink link budget margin based on one or more of a pathloss estimate for the carrier, a maximum transmit power capability of the UE 104-a, or a target received power at the NE 102-a. Otherwise, if the UE 104-a does not support multi-carrier uplink (e.g., the UE 104-a includes a single radio frequency chain or has a reduced power capability), the UE 104-a selects a carrier with a highest downlink RSRP.

The UE 104-a transmits a RACH preamble 512 to the NE 102-a via the uplink communications link 504 on the selected RACH occasion. The NE 102-a receives the RACH preamble 512 and determines an identifier (e.g., an RA-RNTI) for an RAR 514. In some cases, the NE 102-a utilizes a time index, a frequency index, and a fragmented carrier index (FCI) or BWP identifier to determine the RA-RNTI. For example, the NE 102-a calculates the RA-RNTI according to Equation 1:

RA-RNTI=1+t_{id}+14×f_{id}+14×8×FCI, (1)

where t_{id} is a PRACH time index and f_{id} is a frequency index within a carrier. The FCI refers to an index value that identifies a carrier among the set of carriers within the virtual cell, enabling the NE 102-a and the UE 104-a to distinguish between carriers when computing the RA-RNTI. In some examples, Equation 1 implements the FCI when the carriers within the virtual cell are configured as carriers without explicit BWP configurations. In some other examples, Equation 1 implements a BWP identifier in place of the FCI if the NE 102-a configures each carrier as a distinct BWP with an assigned BWP identifier. The RA-RNTI provides a unique RA-RNTI per carrier and avoids ambiguity in Msg2 monitoring.

The NE 102-a transmits the RAR 514 to the UE 104-a via the downlink communications link 502. To monitor for the RAR 514, the UE 104-a computes the RA-RNTI including the FCI and monitors a downlink control channel, such as a PDCCH. In some examples, the NE 102-a transmits the RAR 514 on a downlink carrier corresponding to the same carrier on which the UE 104-a transmitted the RACH preamble 512. In some other examples, the NE 102-a transmits the RAR 514 on a downlink carrier within the virtual cell, and the UE 104-a monitors the PDCCH on each of the carriers using the computed RA-RNTI, where the UE 104-a processes a first matching RAR. The RAR 514 includes a RAPID, timing advance information, a grant (e.g., an uplink grant), a temporary C-RNTI, and/or an FCI if cross-carrier Msg3 is allowed.

The UE 104-a transmits Msg3 516 to the NE 102-a via the uplink communications link 504 using the grant provided in the RAR 514. In some examples, for Msg3 selection, the UE 104-a transmits the Msg3 516 on the same carrier on which the UE 104-a sent the RACH preamble 512. In some other examples, the grant includes a carrier index field or a BWP identifier that maps to a carrier, and the UE 104-a transmits the Msg3 516 on the carrier indicated in the grant. In some other examples, the UE 104-a transmits the RACH preamble 512 on a carrier with a maximum coverage of the carriers, while the NE 102-a schedules the Msg3 516 on a wider-band carrier, a less loaded carrier, or a carrier with improved beam alignment. To avoid coverage issues, the NE 102-a checks a RACH preamble received power margin and reassigns the carrier if an uplink margin exceeds a threshold value. In some other examples, if a PRACH SNR margin is less than a threshold value, then the UE 104-a transmits the Msg3 516 on the same carrier. Otherwise, the NE 102-a provides for cross-carrier Msg3, which prevents Msg3 failure after successful PRACH transmission.

In some cases, the NE 102-a configures a separate RACH configuration index in each carrier or a subset of carriers. The UE 104-a retrieves a PRACH configuration index per carrier, a PRACH periodicity, a slot offset, and PRACH time-domain occasions. The UE 104-a then selects a carrier where an earliest RACH resource is available for PRACH transmission. The UE 104-a calculates a next available PRACH occasion for each carrier and selects a carrier offering an earliest RACH opportunity among eligible (e.g., available) carriers. The UE 104-a incorporates carrier context into the RA-RNTI by including one or more of a carrier index of the carrier or a BWP identifier of the carrier in the RA-RNTI computation to avoid ambiguity, and the UE 104-a monitors for the RAR 514 using the computed RA-RNTI. The UE 104-a transmits the Msg3 516 either on the same carrier or as indicated by the grant, subject to coverage criteria (e.g., uplink power margin, pathloss, or RSRP threshold). In some examples, the UE 104-a repeatedly transmits a same PRACH Msg1 preamble across carriers.

The UE 104-a selects an earliest available carrier, and if coverage is insufficient, then the UE 104-a expands repetition to additional carriers of the set of carriers. For example, the UE 104-a achieves cross-carrier PRACH repetition for coverage enhancement. The cross-carrier PRACH repetition provides frequency diversity by transmitting RACH preamble repetitions across different carriers, which may exhibit hopping-like behavior as the UE 104-a hops between carriers for successive repetitions.

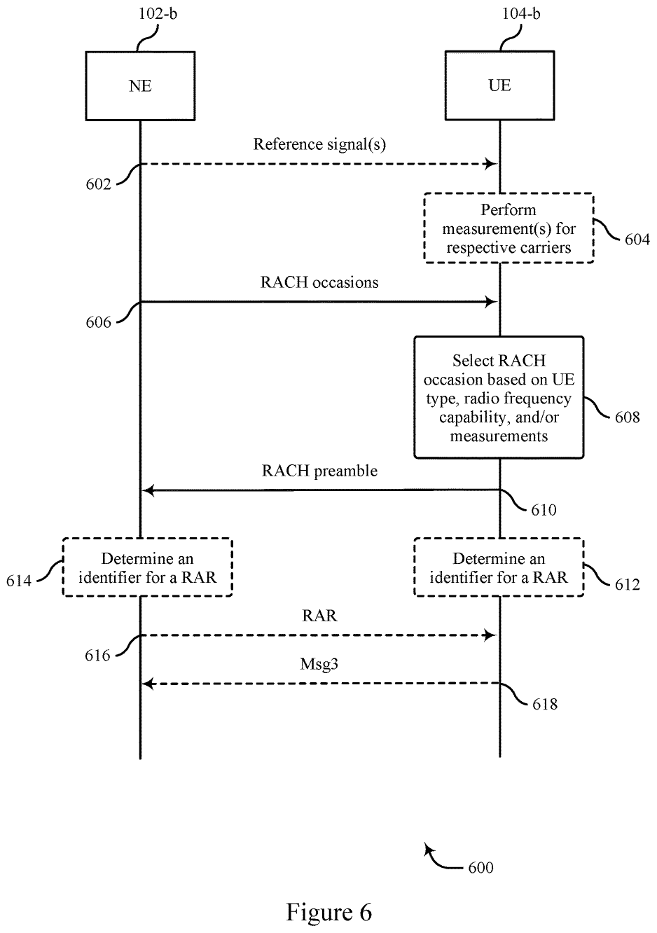

FIG. 6 illustrates an example of a signaling diagram 600 in accordance with aspects of the present disclosure. In some examples, the signaling diagram 600 implements or is implemented by aspects of the wireless communications system 100, the resource diagram 200, the resource diagram 300, the resource diagram 400, and/or the wireless communications system 500. The signaling diagram 600 may implement or be implemented by NE 102-b and UE 104-b, which may be examples of the corresponding devices as described with reference to FIGS. 1 and 5. For example, the NE 102-b may provide the UE 104-b with signaling that indicates a set of RACH occasions spread across a set of carriers associated with a cell (e.g., a single cell, a virtual cell), and the UE 104-b may select a RACH occasion based on at least one of a UE type, a radio frequency capability, or one or more measurements associated with the set of carriers. Alternative examples of the following may be implemented, where some processes are performed in a different order than described or are not performed. In some cases, processes may include additional features not mentioned below, or further processes may be added.

In some examples, at 602, the NE 102-b transmits reference signals to the UE 104-b on one or more carriers of a cell (e.g., a single cell, a virtual cell). In some cases, at 604, the UE 104-b may perform measurements for respective carriers of the cell using the reference signals. For example, the reference signals may include, but are not limited to, SSB signals, CSI-RSs, or other reference signals transmitted on one or more of the carriers within the virtual cell. The UE 104-b may use the reference signals to determine channel conditions for each carrier. The measurements may include, but are not limited to, RSRP measurements, pathloss estimations, or other channel quality measurements for each carrier. For example, the UE 104-b may measure SSB RSRP per carrier or BWP, and may perform uplink pathloss estimation for each carrier. The UE 104-b may compare the measurements to one or more threshold values to determine which carriers satisfy the threshold values for random access.

At 606, the NE 102-b transmits signaling that indicates a set of RACH occasions for a random access procedure to the UE 104-b. The set of RACH occasions are spread across the carriers of the cell. The signaling may include one or more of one or more RACH configuration indices (e.g., PRACH configuration indices) that indicate the RACH occasions, a preamble format of a RACH preamble, a zero correlation zone, and/or one or more power ramping parameters. In some examples, the signaling includes a single RACH configuration index that applies to each of the carriers within the cell, such that the RACH occasions on the carriers share a common periodicity and timing configuration. In some other examples, the signaling may include respective RACH configuration indices for each of the carriers. The respective RACH configuration indices may enable per-carrier configuration of RACH resources and may indicate one or more of a PRACH configuration index, a PRACH periodicity, a slot offset, and/or one or more PRACH time-domain occasions for each carrier.

In some cases, respective carriers are associated with a BWP identifier, and the signaling indicates the BWP identifier. For example, the BWP identifier may be configured by the NE 102-b via RRC signaling, or the BWP identifier may be predefined (e.g., preconfigured or a default configuration) and associated with a respective carrier of the set of carriers. The carriers of the cell may share one or more parameters, such as a PCI, a cell identifier, a synchronization raster, a RACH configuration index, system information, and/or a radio frequency.

At 608, the UE 104-b selects a RACH occasion of the set of RACH occasions based on at least one of a UE type of the UE 104-b, a radio frequency capability of the UE 104-b, or one or more measurements for the set of carriers. The RACH occasion may be associated with a carrier of the set of carriers (e.g., by the signaling at 606). For example, the signaling at 606 indicates time-frequency resources for RACH occasions on each carrier of the set of carriers. The RACH occasion may be associated with the carrier based on a frequency location of the RACH occasion falling within a bandwidth of the carrier, a RACH configuration index that maps the RACH occasion to the carrier, or a BWP identifier that links the RACH occasion to a carrier within the cell.

In some examples, the UE 104-b selects the RACH occasion based on the UE type, and the carrier includes one of a first bandwidth based on the UE being a first UE type or a second bandwidth greater than the first bandwidth based on the UE being a second UE type. For example, an IoT device may select a lowest frequency carrier or a narrower bandwidth carrier, while an XR device or MBB device may select a carrier with a wider bandwidth. Additionally, or alternatively, the UE 104-b selects the RACH occasion based on the radio frequency capability associated with the UE 104-b. For example, the carrier is a first carrier if the radio frequency capability includes a single radio frequency chain. The carrier is a second carrier associated with an RSRP (e.g., a highest RSRP value of the carriers) if the radio frequency capability includes a set of radio frequency chains. The carrier is a third carrier associated with a pathloss (e.g., a lowest pathloss value) if the radio frequency capability includes a reduced power capability. Additionally, or alternatively, the UE 104-b selects the RACH occasion based on the one or more measurements for the carrier satisfying one or more threshold values. For example, satisfying a threshold may include the one or more measurements being greater than or equal to the one or more threshold values (e.g., an RSRP measurement exceeding a minimum RSRP threshold), or the one or more measurements being less than or equal to the one or more threshold values (e.g., a pathloss measurement being below a maximum pathloss threshold).

In some examples, the UE 104-b determines an earliest RACH occasion for respective carriers of the set of carriers. For example, the UE 104-b may determine the earliest RACH occasion by comparing the RACH configuration indices of respective carriers. The UE 104-b may determine a next available RACH occasion for each carrier based on the PRACH periodicity and slot offset, and may select the carrier having the RACH occasion that occurs first in time relative to the other carriers.

At 610, the UE 104-b transmits a RACH preamble of the random access procedure to the NE 102-b based on the selected RACH occasion. For example, the UE 104-b transmits the RACH preamble on the carrier associated with the selected RACH occasion. In some examples, the UE 104-b selects one or more additional RACH occasions of the set of RACH occasions, where the one or more additional RACH occasions are associated with one or more additional carriers of the set of carriers. The UE 104-b transmits one or more repetitions of the RACH preamble based on the one or more additional RACH occasions for coverage enhancement.

In some examples, at 612, the UE 104-b determines an identifier for an RAR of the random access procedure. The identifier is based on one or more of a time index associated with the RACH preamble, a frequency index associated with the RACH preamble, a carrier index associated with the carrier, or a BWP identifier associated with the carrier. For example, the identifier may be an RA-RNTI calculated according to Equation 1. Additionally, or alternatively, the identifier may include one or more of a temporary C-RNTI or another type of identifier that enables the UE 104-b to monitor for and receive the RAR from the NE 102-b. The identifier provides a unique identifier per carrier and prevents or reduces ambiguity in RAR monitoring.

In some cases, at 614, the NE 102-b determines an identifier for the RAR of the random access procedure (e.g., the same identifier as the UE 104-b at 612). The identifier is based on one or more of a time index associated with the RACH preamble, a frequency index associated with the RACH preamble, a carrier index associated with the carrier, or a BWP identifier associated with the carrier. For example, the identifier may be an RA-RNTI calculated according to Equation 1. Additionally, or alternatively, the identifier may include one or more of a temporary C-RNTI or another type of identifier that enables the UE 104-b to monitor for and receive the RAR from the NE 102-b.

In some examples, at 616, the NE 102-b transmits the RAR to the UE 104-b based on the identifier. The RAR may include the carrier index. The RAR may also include a RAPID, timing advance information, an uplink grant, a temporary C-RNTI, and/or a fragmented carrier indicator if cross-carrier Msg3 is enabled. The UE 104-b monitors for the RAR based on at least one carrier of the set of carriers. In some examples, the UE 104-b receives the RAR based on monitoring the carrier on which the RACH preamble was transmitted. In some other examples, the UE 104-b receives the RAR based on monitoring the set of carriers, where the at least one carrier includes the RAR associated with the identifier. In some cases, the NE 102-b transmits a grant that indicates at least one of a carrier index or a BWP identifier associated with an additional carrier of the set of carriers. The grant may be transmitted based on a power margin associated with the RACH preamble satisfying a threshold value.

In some cases, at 618, the UE 104-b transmits a Msg3 of the random access procedure to the NE 102-b. In some examples, the UE 104-b transmits the Msg3 on the carrier on which the RACH preamble was transmitted. In some other examples, the UE 104-b receives a grant that indicates at least one of a carrier index or a BWP identifier associated with an additional carrier of the set of carriers, and transmits the Msg3 on the additional carrier. In some examples, the UE 104-b transmits the Msg3 across two or more carriers of the set of carriers based on an SNR associated with the RACH preamble satisfying a threshold value. The NE 102-b receives the Msg3 on the carrier or the additional carrier, or receives the Msg3 across two or more carriers of the set of carriers based on the SNR associated with the RACH preamble satisfying the threshold value.

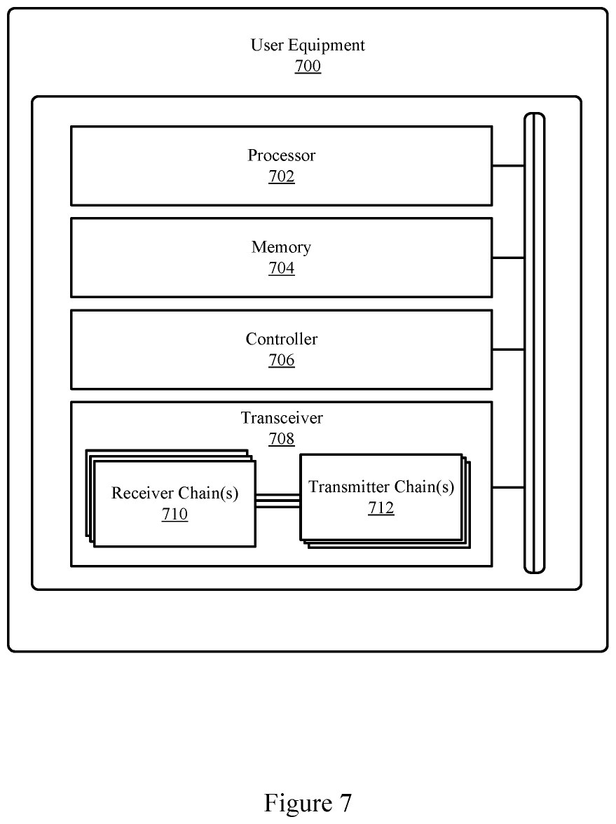

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a central processing unit (CPU), an ASIC, a field-programmable gate-array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions that, when executed by the processor 702, cause the UE 700 to perform various functions described herein. The code may be stored in a non-transitory computer-readable medium such as the memory 704 or another type of memory. Computer-readable media include both non-transitory computer storage media and communication media, including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving signaling that indicates a set of RACH occasions for a random access procedure, where the set of RACH occasions are spread across a set of carriers associated with a cell, selecting, based on at least one of a UE type associated with the UE, a radio frequency capability associated with the UE, or one or more measurements associated with the set of carriers, a RACH occasion of the set of RACH occasions, where the RACH occasion is associated with a carrier of the set of carriers, and transmitting a RACH preamble of the random access procedure based on the RACH occasion. By receiving signaling indicating RACH occasions spread across multiple carriers and selecting a RACH occasion based on UE type, radio frequency capability, or measurements, the UE 700 may provide improved flexibility, reduced latency, and enhanced performance during random access procedures by enabling selection of an earliest available RACH occasion or a RACH occasion on a carrier with improved channel conditions.

Additionally, the UE 700 may be configured to or operable to support any one or combination of the RACH occasion is selected based on the UE type, and the carrier includes one of a first bandwidth based on the UE being a first UE type or a second bandwidth greater than the first bandwidth based on the UE being a second UE type. By selecting a carrier with a bandwidth corresponding to the UE type, the UE 700 may provide efficient resource utilization by matching carrier bandwidth to device capabilities. Additionally, or alternatively, the UE 700 may be configured to or operable to support the RACH occasion is selected based on the radio frequency capability associated with the UE, and the carrier includes one of a first carrier based on the radio frequency capability including a single radio frequency chain, a second carrier associated with an RSRP based on the radio frequency capability including a set of radio frequency chains, or a third carrier associated with a pathloss based on the radio frequency capability including a reduced power capability. By selecting a carrier based on radio frequency capability, the UE 700 may provide improved random access success rates and reduced power consumption by matching carrier selection to the hardware capabilities of the UE. Additionally, or alternatively, the UE 700 may be configured to or operable to support receiving one or more reference signals and performing, for respective carriers of the set of carriers, the one or more measurements associated with the one or more reference signals, where the RACH occasion is selected based on one or more threshold values associated with the one or more measurements, and where the one or more measurements for the carrier satisfy the one or more threshold values. By performing measurements for respective carriers and selecting a RACH occasion based on threshold values, the UE 700 may provide improved random access success rates and reduced power consumption by preventing or reducing transmissions on carriers with channel conditions less than a threshold value.

Additionally, or alternatively, the UE 700 may be configured to or operable to support determining an identifier associated with an RAR of the random access procedure, where the identifier is based on one or more of a time index associated with the RACH preamble, a frequency index associated with the RACH preamble, a carrier index associated with the carrier, or a BWP identifier associated with the carrier, and monitoring for the RAR based on at least one carrier of the set of carriers, where the RAR includes the carrier index. By determining an identifier based on carrier-related parameters and monitoring for the RAR, the UE 700 may provide improved reliability and reduced ambiguity in RARs across multiple carriers. Additionally, or alternatively, to monitor for the RAR, the UE 700 may be configured to or operable to support receiving the RAR based on monitoring the carrier, where the at least one carrier includes the carrier. By monitoring the same carrier on which the RACH preamble was transmitted, the UE 700 may provide reduced complexity and power consumption during RAR reception. Additionally, or alternatively, to monitor for the RAR, the UE 700 may be configured to or operable to support receiving the RAR based on monitoring the set of carriers, where the at least one carrier includes the RAR associated with the identifier. By monitoring the set of carriers for the RAR, the UE 700 may provide improved flexibility and increased likelihood of successful RAR reception across multiple carriers.

Additionally, or alternatively, the UE 700 may be configured to or operable to support transmitting a Msg3 of the random access procedure on the carrier. By transmitting Msg3 on the same carrier as the RACH preamble, the UE 700 may provide reduced complexity and consistent channel conditions for the random access procedure. Additionally, or alternatively, the UE 700 may be configured to or operable to support receiving a grant that indicates at least one of a carrier index or a BWP identifier associated with an additional carrier of the set of carriers and transmitting a Msg3 of the random access procedure on the additional carrier. By receiving a grant indicating an additional carrier and transmitting Msg3 on the additional carrier, the UE 700 may provide improved flexibility and load balancing across multiple carriers. Additionally, or alternatively, the UE 700 may be configured to or operable to support transmitting, based on an SNR associated with the RACH preamble satisfying a threshold value, a Msg3 across two or more carriers of the set of carriers. By transmitting Msg3 across two or more carriers when the SNR satisfies a threshold value, the UE 700 may provide improved reliability and diversity gain for Msg3 transmission.

Additionally, or alternatively, the UE 700 may be configured to or operable to support the signaling includes respective RACH configuration indices associated with the set of carriers that indicate one or more of a PRACH configuration index, a PRACH periodicity, a slot offset, or one or more PRACH time-domain occasions, and determining, for respective carriers of the set of carriers, an earliest RACH occasion for the random access procedure, where the carrier includes the earliest RACH occasion of the respective carriers. By determining an earliest RACH occasion across the set of carriers, the UE 700 may provide reduced random access latency by selecting the first available RACH occasion. Additionally, or alternatively, the UE 700 may be configured to or operable to support selecting one or more additional RACH occasions of the set of RACH occasions, where the one or more additional RACH occasions are associated with one or more additional carriers of the set of carriers, and transmitting one or more repetitions of the RACH preamble based on the one or more additional RACH occasions. By selecting additional RACH occasions on additional carriers and transmitting repetitions of the RACH preamble, the UE 700 may provide improved random access success rates through frequency diversity and increased transmission opportunities. Additionally, or alternatively, the UE 700 may be configured to or operable to support the signaling includes one or more of a PRACH configuration index that indicates the set of RACH occasions, a preamble format associated with the RACH preamble, a zero correlation zone, or one or more power ramping parameters. By receiving signaling including PRACH configuration parameters, the UE 700 may provide efficient configuration of random access resources across multiple carriers. Additionally, or alternatively, the UE 700 may be configured to or operable to support respective carriers of the set of carriers are associated with a BWP identifier, and the signaling indicates the BWP identifier. By associating carriers with BWP identifiers indicated in the signaling, the UE 700 may provide improved resource management and identification of carriers within the cell. Additionally, or alternatively, the UE 700 may be configured to or operable to support the set of carriers are associated with the cell based on the set of carriers sharing one or more of a PCI, a cell identifier, a synchronization raster, a RACH configuration index, system information, or a radio frequency. By associating carriers with the cell based on shared parameters, the UE 700 may provide simplified cell management and consistent random access configuration across multiple carriers within a virtual cell.

Additionally, or alternatively, the UE 700 may support at least one memory (e.g., the memory 704) and at least one processor (e.g., the processor 702) coupled with the at least one memory and configured to cause the UE to receive signaling that indicates a set of RACH occasions for a random access procedure, where the set of RACH occasions are spread across a set of carriers associated with a cell, select, based on at least one of a UE type associated with the UE, a radio frequency capability associated with the UE, or one or more measurements associated with the set of carriers, a RACH occasion of the set of RACH occasions, where the RACH occasion is associated with a carrier of the set of carriers, and transmit a RACH preamble of the random access procedure based on the RACH occasion.

Additionally, to select the RACH occasion, the UE 700 may be configured to support any one or combination of the RACH occasion is selected based on the UE type, and the carrier includes one of a first bandwidth based on the UE being a first UE type or a second bandwidth greater than the first bandwidth based on the UE being a second UE type. Additionally, or alternatively, the UE 700 may be configured to or operable to support the RACH occasion is selected based on the radio frequency capability associated with the UE, and the carrier includes one of a first carrier based on the radio frequency capability including a single radio frequency chain, a second carrier associated with an RSRP based on the radio frequency capability including a set of radio frequency chains, or a third carrier associated with a pathloss based on the radio frequency capability including a reduced power capability. Additionally, or alternatively, the UE 700 may be configured to or operable to support to receive one or more reference signals and perform, for respective carriers of the set of carriers, the one or more measurements associated with the one or more reference signals, where the RACH occasion is selected based on one or more threshold values associated with the one or more measurements, and where the one or more measurements for the carrier satisfy the one or more threshold values.

Additionally, or alternatively, the UE 700 may be configured to or operable to support to determine an identifier associated with an RAR of the random access procedure, where the identifier is based on one or more of a time index associated with the RACH preamble, a frequency index associated with the RACH preamble, a carrier index associated with the carrier, or a BWP identifier associated with the carrier, and monitor for the RAR based on at least one carrier of the set of carriers, where the RAR includes the carrier index. Additionally, or alternatively, to monitor for the RAR, the UE 700 may be configured to or operable to support to receive the RAR based on monitoring the carrier, where the at least one carrier includes the carrier. Additionally, or alternatively, to monitor for the RAR, the UE 700 may be configured to or operable to support to receive the RAR based on monitoring the set of carriers, where the at least one carrier includes the RAR associated with the identifier.

Additionally, or alternatively, the UE 700 may be configured to or operable to support to transmit a Msg3 of the random access procedure on the carrier. Additionally, or alternatively, the UE 700 may be configured to or operable to support to receive a grant that indicates at least one of a carrier index or a BWP identifier associated with an additional carrier of the set of carriers and transmit a Msg3 of the random access procedure on the additional carrier. Additionally, or alternatively, the UE 700 may be configured to or operable to support to transmit, based on an SNR associated with the RACH preamble satisfying a threshold value, a Msg3 across two or more carriers of the set of carriers.

Additionally, or alternatively, the UE 700 may be configured to or operable to support the signaling includes respective RACH configuration indices associated with the set of carriers that indicate one or more of a PRACH configuration index, a PRACH periodicity, a slot offset, or one or more PRACH time-domain occasions, and to determine, for respective carriers of the set of carriers, an earliest RACH occasion for the random access procedure, where the carrier includes the earliest RACH occasion of the respective carriers. Additionally, or alternatively, the UE 700 may be configured to or operable to support to select one or more additional RACH occasions of the set of RACH occasions, where the one or more additional RACH occasions are associated with one or more additional carriers of the set of carriers, and transmit one or more repetitions of the RACH preamble based on the one or more additional RACH occasions. Additionally, or alternatively, the UE 700 may be configured to or operable to support the signaling includes one or more of a PRACH configuration index that indicates the set of RACH occasions, a preamble format associated with the RACH preamble, a zero correlation zone, or one or more power ramping parameters. Additionally, or alternatively, the UE 700 may be configured to or operable to support respective carriers of the set of carriers are associated with a BWP identifier, and the signaling indicates the BWP identifier. Additionally, or alternatively, the UE 700 may be configured to or operable to support the set of carriers are associated with the cell based on the set of carriers sharing one or more of a PCI, a cell identifier, a synchronization raster, a RACH configuration index, system information, or a radio frequency.

The controller 706 may manage input and output signals for the UE 700. The controller 706 may also manage peripherals not integrated into the UE 700. In some implementations, the controller 706 may utilize an operating system such as iOS®, Android®, Windows®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

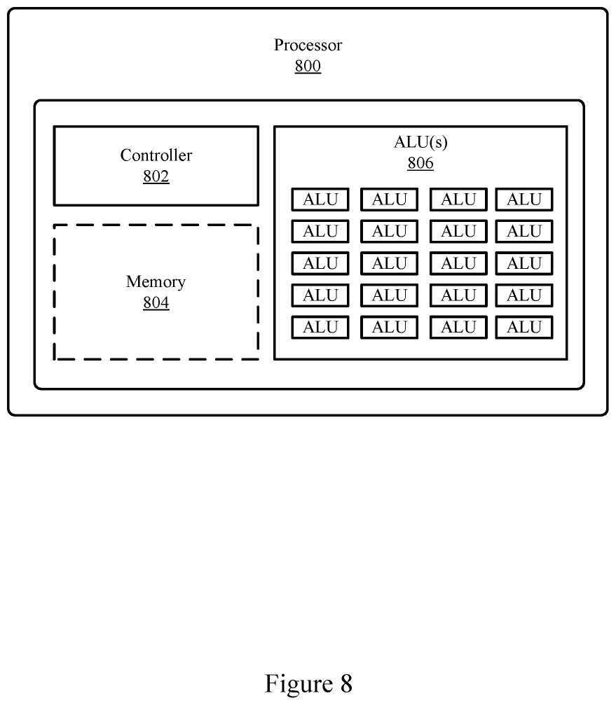

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc.). In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations, such as addition, subtraction, multiplication, and division, on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations, such as AND, OR, exclusive-OR (XOR), not-OR (NOR), and not-AND (NAND), enabling the one or more ALUs 806 to handle conditional operations, comparisons, and bitwise operations.

The processor 800 may be configured to, or operable to, support at least one controller (e.g., the controller 802) coupled with at least one memory (e.g., the memory 804) and configured to cause the processor to receive signaling that indicates a set of RACH occasions for a random access procedure, where the set of RACH occasions are spread across a set of carriers associated with a cell, select, based on at least one of a UE type associated with the UE, a radio frequency capability associated with the UE, or one or more measurements associated with the set of carriers, a RACH occasion of the set of RACH occasions, where the RACH occasion is associated with a carrier of the set of carriers, and transmit a RACH preamble of the random access procedure based on the RACH occasion. By receiving signaling indicating RACH occasions spread across multiple carriers and selecting a RACH occasion based on UE type, radio frequency capability, or measurements, the processor 800 enables improved flexibility and reduced latency during random access procedures, as well as enhanced resource utilization efficiency across the multiple carriers associated with the cell.

Additionally, the processor 800 may be configured to or operable to support any one or combination of the RACH occasion is selected based on the UE type, and the carrier includes one of a first bandwidth based on the UE being a first UE type or a second bandwidth greater than the first bandwidth based on the UE being a second UE type. Selecting the RACH occasion based on UE type enables the processor 800 to match carrier bandwidth to device capabilities, thereby improving resource allocation and improving random access success rates for different UE types. Additionally, or alternatively, the processor 800 may be configured to or operable to support the RACH occasion is selected based on the radio frequency capability associated with the UE, and the carrier includes one of a first carrier based on the radio frequency capability including a single radio frequency chain, a second carrier associated with an RSRP based on the radio frequency capability including a set of radio frequency chains, or a third carrier associated with a pathloss based on the radio frequency capability including a reduced power capability. Selecting the carrier based on radio frequency capability enables the processor 800 to improve carrier selection according to hardware capabilities, thereby reducing power consumption and improving transmission reliability for UEs with varying radio frequency capabilities. Additionally, or alternatively, the processor 800 may be configured to or operable to support to receive one or more reference signals and perform, for respective carriers of the set of carriers, the one or more measurements associated with the one or more reference signals, where the RACH occasion is selected based on one or more threshold values associated with the one or more measurements, and where the one or more measurements for the carrier satisfy the one or more threshold values. Performing measurements and selecting RACH occasions based on threshold values enables the processor 800 to identify carriers with favorable channel conditions, thereby improving random access success rates and reducing power consumption by avoiding transmissions on carriers with channel quality below a threshold value.

Additionally, or alternatively, the processor 800 may be configured to or operable to support to determine an identifier associated with an RAR of the random access procedure, where the identifier is based on one or more of a time index associated with the RACH preamble, a frequency index associated with the RACH preamble, a carrier index associated with the carrier, or a BWP identifier associated with the carrier, and monitor for the RAR based on at least one carrier of the set of carriers, where the RAR includes the carrier index. Determining the identifier based on carrier-related parameters enables the processor 800 to accurately identify and receive the RAR across multiple carriers, thereby supporting efficient RAR handling in multi-carrier configurations. Additionally, or alternatively, to monitor for the RAR, the processor 800 may be configured to or operable to support to receive the RAR based on monitoring the carrier, where the at least one carrier includes the carrier. Monitoring the same carrier used for RACH preamble transmission simplifies RAR reception and reduces monitoring complexity at the processor 800. Additionally, or alternatively, to monitor for the RAR, the processor 800 may be configured to or operable to support to receive the RAR based on monitoring the set of carriers, where the at least one carrier includes the RAR associated with the identifier. Monitoring the set of carriers for the RAR provides flexibility in RAR reception and enables the processor 800 to receive responses across different carriers within the cell. Additionally, or alternatively, the processor 800 may be configured to or operable to support to transmit a Msg3 of the random access procedure on the carrier. Transmitting Msg3 on the same carrier as the RACH preamble maintains consistency in the random access procedure and simplifies resource allocation. Additionally, or alternatively, the processor 800 may be configured to or operable to support to receive a grant that indicates at least one of a carrier index or a BWP identifier associated with an additional carrier of the set of carriers and transmit a Msg3 of the random access procedure on the additional carrier. Receiving a grant indicating an additional carrier for Msg3 transmission enables the processor 800 to utilize alternative carriers with improved channel conditions or available resources, thereby improving transmission reliability.

Additionally, or alternatively, the processor 800 may be configured to or operable to support to transmit, based on an SNR associated with the RACH preamble satisfying a threshold value, a Msg3 across two or more carriers of the set of carriers. Transmitting Msg3 across multiple carriers when SNR conditions are favorable enables the processor 800 to leverage carrier diversity for improved reliability and throughput. Additionally, or alternatively, the processor 800 may be configured to or operable to support the signaling includes respective RACH configuration indices associated with the set of carriers that indicate one or more of a PRACH configuration index, a PRACH periodicity, a slot offset, or one or more PRACH time-domain occasions, and to determine, for respective carriers of the set of carriers, an earliest RACH occasion for the random access procedure, where the carrier includes the earliest RACH occasion of the respective carriers. Determining the earliest RACH occasion across multiple carriers enables the processor 800 to reduce random access latency by selecting the soonest available opportunity for RACH preamble transmission. Additionally, or alternatively, the processor 800 may be configured to or operable to support to select one or more additional RACH occasions of the set of RACH occasions, where the one or more additional RACH occasions are associated with one or more additional carriers of the set of carriers, and transmit one or more repetitions of the RACH preamble based on the one or more additional RACH occasions. Selecting additional RACH occasions across multiple carriers for preamble repetitions enables the processor 800 to improve random access success probability through frequency diversity.

Additionally, or alternatively, the processor 800 may be configured to or operable to support the signaling includes one or more of a PRACH configuration index that indicates the set of RACH occasions, a preamble format associated with the RACH preamble, a zero correlation zone, or one or more power ramping parameters. Including PRACH configuration parameters in the signaling enables the processor 800 to configure random access transmissions according to network criteria. Additionally, or alternatively, the processor 800 may be configured to or operable to support respective carriers of the set of carriers are associated with a BWP identifier, and the signaling indicates the BWP identifier. Associating carriers with BWP identifiers enables the processor 800 to efficiently identify and utilize BWPs across the multiple carriers. Additionally, or alternatively, the processor 800 may be configured to or operable to support the set of carriers are associated with the cell based on the set of carriers sharing one or more of a PCI, a cell identifier, a synchronization raster, a RACH configuration index, system information, or a radio frequency. Associating multiple carriers with a single cell through shared identifiers and configuration parameters enables the processor 800 to treat the carriers as a unified resource pool, thereby simplifying cell management and improving resource utilization efficiency.

The processor 800 may be configured to or operable to support at least one controller (e.g., the controller 802) coupled with at least one memory (e.g., the memory 804) and configured to cause the processor to transmit signaling that indicates a set of RACH occasions for a random access procedure, where the set of RACH occasions are spread across a set of carriers associated with a cell, and receive, from a UE and based on at least one of a UE type associated with the UE, a radio frequency capability associated with the UE, or one or more measurements associated with the set of carriers, a RACH preamble of the random access procedure on a RACH occasion of the set of RACH occasions, where the RACH occasion is associated with a carrier of the set of carriers. By transmitting signaling indicating RACH occasions spread across multiple carriers and receiving RACH preambles based on UE-specific parameters, the processor 800 enables efficient resource utilization across the multiple carriers and supports diverse UE capabilities within the cell.

Additionally, the processor 800 may be configured to or operable to support any one or combination of to determine an identifier associated with an RAR of the random access procedure, where the identifier is based on one or more of a time index associated with the RACH preamble, a frequency index associated with the RACH preamble, a carrier index associated with the carrier, or a BWP identifier associated with the carrier, and transmit the RAR based on the identifier, where the RAR includes the carrier index. Determining the identifier based on carrier-related parameters enables the processor 800 to accurately address the RAR to a UE across multiple carriers, thereby supporting efficient RAR delivery in multi-carrier configurations. Additionally, or alternatively, the processor 800 may be configured to or operable to support to receive a Msg3 of the random access procedure on the carrier. Receiving Msg3 on the same carrier as the RACH preamble maintains consistency in the random access procedure and simplifies resource management at the processor 800. Additionally, or alternatively, the processor 800 may be configured to or operable to support to transmit a grant that indicates at least one of a carrier index or a BWP identifier associated with an additional carrier of the set of carriers and receive a Msg3 of the random access procedure on the additional carrier. Transmitting a grant indicating an additional carrier for Msg3 reception enables the processor 800 to direct UE transmissions to carriers with better channel conditions or available resources, thereby improving reception reliability and load balancing.

Additionally, or alternatively, the processor 800 may be configured to or operable to support the grant is transmitted based on a power margin associated with the RACH preamble satisfying a threshold value. Transmitting the grant based on power margin enables the processor 800 to redirect UE transmissions to alternative carriers if the UE has sufficient power headroom, thereby improving resource allocation across carriers. Additionally, or alternatively, the processor 800 may be configured to or operable to support to receive, based on an SNR associated with the RACH preamble satisfying a threshold value, a Msg3 across two or more carriers of the set of carriers. Receiving Msg3 across multiple carriers with improved SNR enables the processor 800 to leverage carrier diversity for improved reception reliability and throughput. Additionally, or alternatively, the processor 800 may be configured to or operable to support the signaling includes respective RACH configuration indices associated with the set of carriers that indicate one or more of a PRACH configuration index, a PRACH periodicity, a slot offset, or one or more PRACH time-domain occasions. Including carrier-specific RACH configuration indices in the signaling enables the processor 800 to configure distinct RACH occasion patterns across multiple carriers, thereby providing flexibility in resource allocation and reducing RACH occasion collisions. Additionally, or alternatively, the processor 800 may be configured to or operable to support to receive one or more repetitions of the RACH preamble based on one or more additional RACH occasions, where the one or more additional RACH occasions are associated with one or more additional carriers of the set of carriers. Receiving preamble repetitions across multiple carriers enables the processor 800 to improve RACH preamble detection probability through frequency diversity and combining gains.

Additionally, or alternatively, the processor 800 may be configured to or operable to support the signaling includes one or more of a PRACH configuration index that indicates the set of RACH occasions, a preamble format associated with the RACH preamble, a zero correlation zone, or one or more power ramping parameters. Including comprehensive PRACH configuration parameters in the signaling enables the processor 800 to properly configure random access reception according to network criteria and cell coverage characteristics. Additionally, or alternatively, the processor 800 may be configured to or operable to support respective carriers of the set of carriers are associated with a BWP identifier, and the signaling indicates the BWP identifier. Associating carriers with BWP identifiers enables the processor 800 to efficiently manage BWPs across the multiple carriers and coordinate resource allocation. Additionally, or alternatively, the processor 800 may be configured to or operable to support the set of carriers are associated with the cell based on the set of carriers sharing one or more of a PCI, a cell identifier, a synchronization raster, a RACH configuration index, system information, or a radio frequency. Associating multiple carriers with a single cell through shared identifiers and configuration parameters enables the processor 800 to manage the carriers as a unified resource pool, thereby simplifying cell management, reducing signaling overhead, and improving resource utilization efficiency across the cell.

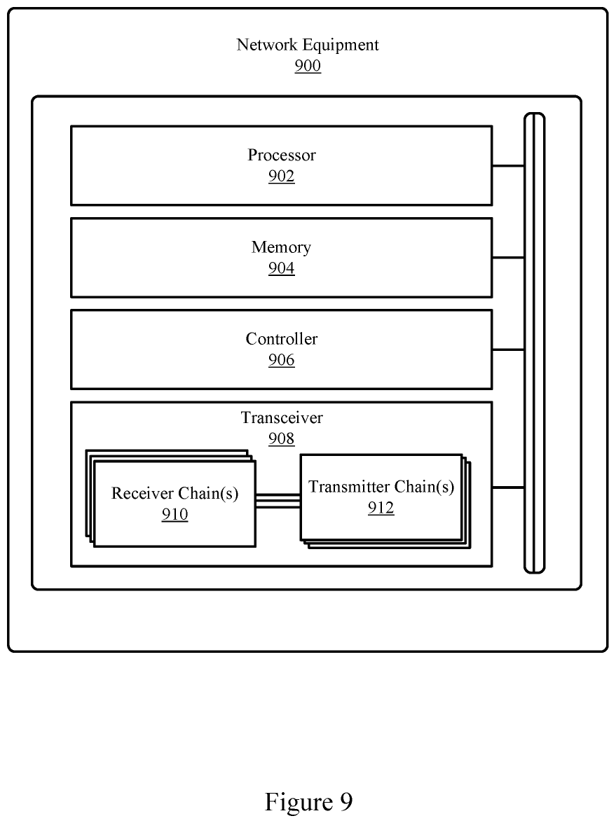

FIG. 9 illustrates an example of an NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a DSP, an ASIC, or other programmable logic device, or any combination thereof, configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code, including instructions that, when executed by the processor 902, cause the NE 900 to perform various functions described herein. The code may be stored in a non-transitory computer-readable medium, such as the memory 904 or another type of memory. Computer-readable media include both non-transitory computer storage media and communication media, including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for transmitting signaling that indicates a set of RACH occasions for a random access procedure, where the set of RACH occasions are spread across a set of carriers associated with a cell, and receiving, from a UE and based on at least one of a UE type associated with the UE, a radio frequency capability associated with the UE, or one or more measurements associated with the set of carriers, a RACH preamble of the random access procedure on a RACH occasion of the set of RACH occasions, where the RACH occasion is associated with a carrier of the set of carriers. By transmitting signaling indicating RACH occasions spread across multiple carriers and receiving RACH preambles based on UE-specific parameters, the NE 900 may provide efficient resource utilization across the multiple carriers and support diverse UE capabilities within the cell.

Additionally, the NE 900 may be configured to or operable to support any one or combination of to determine an identifier associated with an RAR of the random access procedure, where the identifier is based on one or more of a time index associated with the RACH preamble, a frequency index associated with the RACH preamble, a carrier index associated with the carrier, or a BWP identifier associated with the carrier, and transmit the RAR based on the identifier, where the RAR includes the carrier index. By determining the identifier based on carrier-related parameters and transmitting the RAR, the NE 900 may provide improved reliability and reduced ambiguity in addressing RARs across multiple carriers. Additionally, or alternatively, the NE 900 may be configured to or operable to support to receive a Msg3 of the random access procedure on the carrier. By receiving Msg3 on the same carrier as the RACH preamble, the NE 900 may provide reduced complexity and consistent channel conditions for the random access procedure. Additionally, or alternatively, the NE 900 may be configured to or operable to support to transmit a grant that indicates at least one of a carrier index or a BWP identifier associated with an additional carrier of the set of carriers and receive a Msg3 of the random access procedure on the additional carrier. By transmitting a grant indicating an additional carrier and receiving Msg3 on the additional carrier, the NE 900 may provide improved flexibility and load balancing across multiple carriers.

Additionally, or alternatively, the NE 900 may be configured to or operable to support the grant is transmitted based on a power margin associated with the RACH preamble satisfying a threshold value. By transmitting the grant based on power margin, the NE 900 may provide improved resource allocation by directing UE transmissions to alternative carriers if sufficient power headroom exists. Additionally, or alternatively, the NE 900 may be configured to or operable to support to receive, based on an SNR associated with the RACH preamble satisfying a threshold value, a Msg3 across two or more carriers of the set of carriers. By receiving Msg3 across two or more carriers if the SNR satisfies a threshold value, the NE 900 may provide improved reliability and diversity gain for Msg3 reception. Additionally, or alternatively, the NE 900 may be configured to or operable to support the signaling includes respective RACH configuration indices associated with the set of carriers that indicate one or more of a PRACH configuration index, a PRACH periodicity, a slot offset, or one or more PRACH time-domain occasions. By including carrier-specific RACH configuration indices in the signaling, the NE 900 may provide flexibility in resource allocation and reduced RACH occasion collisions across multiple carriers. Additionally, or alternatively, the NE 900 may be configured to or operable to support to receive one or more repetitions of the RACH preamble based on one or more additional RACH occasions, where the one or more additional RACH occasions are associated with one or more additional carriers of the set of carriers. By receiving preamble repetitions across multiple carriers, the NE 900 may provide improved RACH preamble detection probability through frequency diversity and combining gains.

Additionally, or alternatively, the NE 900 may be configured to or operable to support the signaling includes one or more of a PRACH configuration index that indicates the set of RACH occasions, a preamble format associated with the RACH preamble, a zero correlation zone, or one or more power ramping parameters. By including comprehensive PRACH configuration parameters in the signaling, the NE 900 may provide efficient configuration of random access resources across multiple carriers. Additionally, or alternatively, the NE 900 may be configured to or operable to support respective carriers of the set of carriers are associated with a BWP identifier, and the signaling indicates the BWP identifier. By associating carriers with BWP identifiers indicated in the signaling, the NE 900 may provide improved resource management and identification of carriers within the cell. Additionally, or alternatively, the NE 900 may be configured to or operable to support the set of carriers are associated with the cell based on the set of carriers sharing one or more of a PCI, a cell identifier, a synchronization raster, a RACH configuration index, system information, or a radio frequency. By associating carriers with the cell based on shared parameters, the NE 900 may provide simplified cell management and consistent random access configuration across multiple carriers within a virtual cell.

Additionally, or alternatively, the NE 900 may support at least one memory (e.g., the memory 904) and at least one processor (e.g., the processor 902) coupled with the at least one memory and configured to cause the NE to transmit signaling that indicates a set of RACH occasions for a random access procedure, where the set of RACH occasions are spread across a set of carriers associated with a cell, and receive, from a UE and based on at least one of a UE type associated with the UE, a radio frequency capability associated with the UE, or one or more measurements associated with the set of carriers, a RACH preamble of the random access procedure on a RACH occasion of the set of RACH occasions, where the RACH occasion is associated with a carrier of the set of carriers.

Additionally, the NE 900 may be configured to support any one or combination of to determine an identifier associated with an RAR of the random access procedure, where the identifier is based on one or more of a time index associated with the RACH preamble, a frequency index associated with the RACH preamble, a carrier index associated with the carrier, or a BWP identifier associated with the carrier, and transmit the RAR based on the identifier, where the RAR includes the carrier index. Additionally, or alternatively, the NE 900 may be configured to or operable to support to receive a Msg3 of the random access procedure on the carrier. Additionally, or alternatively, the NE 900 may be configured to or operable to support to transmit a grant that indicates at least one of a carrier index or a BWP identifier associated with an additional carrier of the set of carriers and receive a Msg3 of the random access procedure on the additional carrier. Additionally, or alternatively, the NE 900 may be configured to or operable to support the grant is transmitted based on a power margin associated with the RACH preamble satisfying a threshold value. Additionally, or alternatively, the NE 900 may be configured to or operable to support to receive, based on an SNR associated with the RACH preamble satisfying a threshold value, a Msg3 across two or more carriers of the set of carriers.

Additionally, or alternatively, the NE 900 may be configured to or operable to support the signaling includes respective RACH configuration indices associated with the set of carriers that indicate one or more of a PRACH configuration index, a PRACH periodicity, a slot offset, or one or more PRACH time-domain occasions. Additionally, or alternatively, the NE 900 may be configured to or operable to support to receive one or more repetitions of the RACH preamble based on one or more additional RACH occasions, where the one or more additional RACH occasions are associated with one or more additional carriers of the set of carriers. Additionally, or alternatively, the NE 900 may be configured to or operable to support the signaling includes one or more of a PRACH configuration index that indicates the set of RACH occasions, a preamble format associated with the RACH preamble, a zero correlation zone, or one or more power ramping parameters. Additionally, or alternatively, the NE 900 may be configured to or operable to support respective carriers of the set of carriers are associated with a BWP identifier, and the signaling indicates the BWP identifier. Additionally, or alternatively, the NE 900 may be configured to or operable to support the set of carriers are associated with the cell based on the set of carriers sharing one or more of a PCI, a cell identifier, a synchronization raster, a RACH configuration index, system information, or a radio frequency.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., an LNA) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

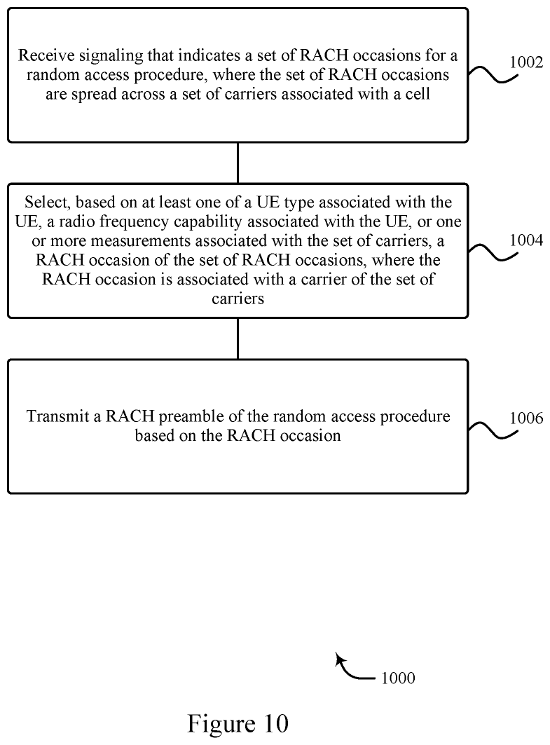

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified, and that other implementations are possible.

At 1002, the method may include receiving signaling that indicates a set of RACH occasions for a random access procedure, where the set of RACH occasions are spread across a set of carriers associated with a cell. The operations of 1002 may be performed in accordance with examples as described herein. In some implementations, aspects of the operations of 1002 may be performed by a UE as described with reference to FIG. 7.

At 1004, the method may include selecting, based on at least one of a UE type associated with the UE, a radio frequency capability associated with the UE, or one or more measurements associated with the set of carriers, a RACH occasion of the set of RACH occasions, where the RACH occasion is associated with a carrier of the set of carriers. The operations of 1004 may be performed in accordance with examples as described herein. In some implementations, aspects of the operations of 1004 may be performed by a UE as described with reference to FIG. 7.

At 1006, the method may include transmitting a RACH preamble of the random access procedure based on the RACH occasion. The operations of 1006 may be performed in accordance with examples as described herein. In some implementations, aspects of the operations of 1006 may be performed by a UE as described with reference to FIG. 7.

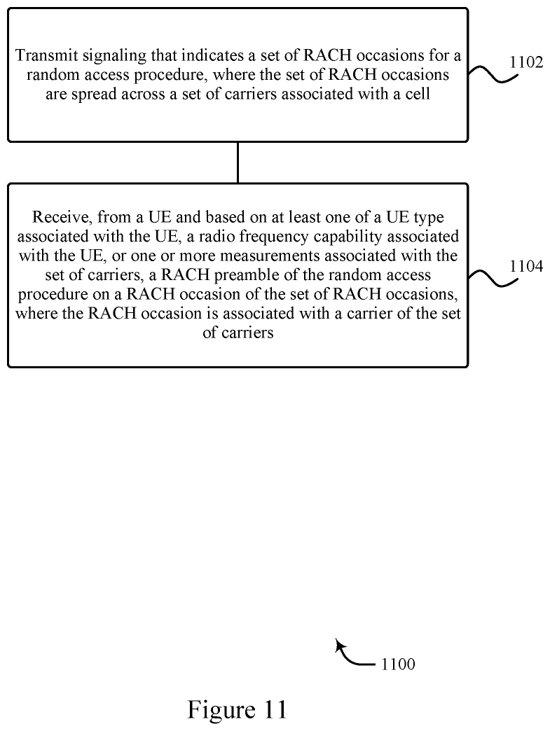

FIG. 11 illustrates a flowchart of a method 1100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified, and that other implementations are possible.

At 1102, the method may include transmitting signaling that indicates a set of RACH occasions for a random access procedure, where the set of RACH occasions are spread across a set of carriers associated with a cell. The operations of 1102 may be performed in accordance with examples as described herein. In some implementations, aspects of the operations of 1102 may be performed by an NE as described with reference to FIG. 9.

At 1104, the method may include receiving, from a UE and based on at least one of a UE type associated with the UE, a radio frequency capability associated with the UE, or one or more measurements associated with the set of carriers, a RACH preamble of the random access procedure on a RACH occasion of the set of RACH occasions, where the RACH occasion is associated with a carrier of the set of carriers. The operations of 1104 may be performed in accordance with examples as described herein. In some implementations, aspects of the operations of 1104 may be performed by an NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive signaling that indicates a plurality of random access channel (RACH) occasions for a random access procedure, wherein the plurality of RACH occasions are spread across a plurality of carriers associated with a cell;
select, based at least in part on at least one of a UE type associated with the UE, a radio frequency capability associated with the UE, or one or more measurements associated with the plurality of carriers, a RACH occasion of the plurality of RACH occasions, wherein the RACH occasion is associated with a carrier of the plurality of carriers; and
transmit a RACH preamble of the random access procedure based at least in part on the RACH occasion.

2. The UE of claim 1, wherein the RACH occasion is selected based at least in part on the UE type, and wherein the carrier comprises one of a first bandwidth based at least in part on the UE being a first UE type or a second bandwidth greater than the first bandwidth based at least in part on the UE being a second UE type.

3. The UE of claim 1, wherein the RACH occasion is selected based at least in part on the radio frequency capability associated with the UE, and wherein the carrier comprises one of:
a first carrier based at least in part on the radio frequency capability comprising a single radio frequency chain;
a second carrier associated with a reference signal received power (RSRP) based at least in part on the radio frequency capability comprising a plurality of radio frequency chains; or
a third carrier associated with a pathloss based at least in part on the radio frequency capability comprising a reduced power capability.

4. The UE of claim 1, wherein the at least one processor is further operable to cause the UE to:
receive one or more reference signals; and
perform, for respective carriers of the plurality of carriers, the one or more measurements associated with the one or more reference signals, wherein the RACH occasion is selected based at least in part on one or more threshold values associated with the one or more measurements, and wherein the one or more measurements for the carrier satisfy the one or more threshold values.

5. The UE of claim 1, wherein the at least one processor is further operable to cause the UE to:
determine an identifier associated with a random access response (RAR) of the random access procedure, wherein the identifier is based at least in part on one or more of a time index associated with the RACH preamble, a frequency index associated with the RACH preamble, a carrier index associated with the carrier, or a bandwidth part (BWP) identifier associated with the carrier; and
monitor for the RAR based at least in part on at least one carrier of the plurality of carriers, wherein the RAR comprises the carrier index.

6. The UE of claim 5, wherein to monitor for the RAR, the at least one processor is operable to cause the UE to receive the RAR based at least in part on monitoring the carrier, wherein the at least one carrier comprises the carrier.

7. The UE of claim 5, wherein to monitor for the RAR, the at least one processor is operable to cause the UE to receive the RAR based at least in part on monitoring the plurality of carriers, wherein the at least one carrier comprises the RAR associated with the identifier.

8. The UE of claim 1, wherein the at least one processor is further operable to cause the UE to transmit a third message (Msg3) of the random access procedure on the carrier.

9. The UE of claim 1, wherein the at least one processor is further operable to cause the UE to:
receive a grant that indicates at least one of a carrier index or a bandwidth part (BWP) identifier associated with an additional carrier of the plurality of carriers; and
transmit a third message (Msg3) of the random access procedure on the additional carrier.

10. The UE of claim 1, wherein the at least one processor is further operable to cause the UE to transmit, based at least in part on a signal-to-noise ratio (SNR) associated with the RACH preamble satisfying a threshold value, a third message (Msg3) across two or more carriers of the plurality of carriers.

11. The UE of claim 1, wherein the signaling comprises respective RACH configuration indices associated with the plurality of carriers that indicate one or more of a physical RACH (PRACH) configuration index, a PRACH periodicity, a slot offset, or one or more PRACH time-domain occasions, and wherein the at least one processor is further operable to cause the UE to determine, for respective carriers of the plurality of carriers, an earliest RACH occasion for the random access procedure, wherein the carrier comprises the earliest RACH occasion of the respective carriers.

12. The UE of claim 1, wherein the at least one processor is further operable to cause the UE to:
select one or more additional RACH occasions of the plurality of RACH occasions, wherein the one or more additional RACH occasions are associated with one or more additional carriers of the plurality of carriers; and
transmit one or more repetitions of the RACH preamble based at least in part on the one or more additional RACH occasions.

13. The UE of claim 1, wherein the signaling comprises one or more of a physical RACH (PRACH) configuration index that indicates the plurality of RACH occasions, a preamble format associated with the RACH preamble, a zero correlation zone, or one or more power ramping parameters.

14. The UE of claim 1, wherein respective carriers of the plurality of carriers are associated with a bandwidth part (BWP) identifier, and wherein the signaling indicates the BWP identifier.

15. The UE of claim 1, wherein the plurality of carriers are associated with the cell based at least in part on the plurality of carriers sharing one or more of a physical cell identifier (PCI), a cell identifier, a synchronization raster, a RACH configuration index, system information, or a radio frequency.

16. A method performed by a user equipment (UE), the method comprising:
receiving signaling that indicates a plurality of random access channel (RACH) occasions for a random access procedure, wherein the plurality of RACH occasions are spread across a plurality of carriers associated with a cell;
selecting, based at least in part on at least one of a UE type associated with the UE, a radio frequency capability associated with the UE, or one or more measurements associated with the plurality of carriers, a RACH occasion of the plurality of RACH occasions, wherein the RACH occasion is associated with a carrier of the plurality of carriers; and
transmitting a RACH preamble of the random access procedure based at least in part on the RACH occasion.

17. A network equipment (NE) for wireless communication, comprising:
at least one memory; and
at least one processor coupled with the at least one memory and operable to cause the NE to:
transmit signaling that indicates a plurality of random access channel (RACH) occasions for a random access procedure, wherein the plurality of RACH occasions are spread across a plurality of carriers associated with a cell; and
receive, from a user equipment (UE) and based at least in part on at least one of a UE type associated with the UE, a radio frequency capability associated with the UE, or one or more measurements associated with the plurality of carriers, a RACH preamble of the random access procedure on a RACH occasion of the plurality of RACH occasions, wherein the RACH occasion is associated with a carrier of the plurality of carriers.

18. The NE of claim 17, wherein the at least one processor is further operable to cause the NE to:
determine an identifier associated with a random access response (RAR) of the random access procedure, wherein the identifier is based at least in part on one or more of a time index associated with the RACH preamble, a frequency index associated with the RACH preamble, a carrier index associated with the carrier, or a bandwidth part (BWP) identifier associated with the carrier; and
transmit the RAR based at least in part on the identifier, wherein the RAR comprises the carrier index.

19. The NE of claim 17, wherein the at least one processor is further operable to cause the NE to:
transmit a grant that indicates at least one of a carrier index or a bandwidth part (BWP) identifier associated with an additional carrier of the plurality of carriers, wherein the grant is transmitted based at least in part on a power margin associated with the RACH preamble satisfying a threshold value; and
receive a third message (Msg3) of the random access procedure on the additional carrier.

20. A method performed by a network equipment (NE), the method comprising:
transmitting signaling that indicates a plurality of random access channel (RACH) occasions for a random access procedure, wherein the plurality of RACH occasions are spread across a plurality of carriers associated with a cell; and
receiving, from a user equipment (UE) and based at least in part on at least one of a UE type associated with the UE, a radio frequency capability associated with the UE, or one or more measurements associated with the plurality of carriers, a RACH preamble of the random access procedure on a RACH occasion of the plurality of RACH occasions, wherein the RACH occasion is associated with a carrier of the plurality of carriers.
